(19) United States
(12) Patent Application Publication
(10) Pub. No.: US 2024/0309635 A1
(43) Pub. Date: Sep. 19, 2024

(54) SYSTEM AND METHOD FOR REDUCTION OF MOISTURE IN POROUS MATERIALS

(71) Applicant: eAmbient, Inc., Northampton, MA (US)

(72) Inventors: Andreas Calianos, Northampton, MA (US); John-Paul Pollard, Surbiton (GB)

(73) Assignee: eAmbient, Inc., Northampton, MA (US)

(21) Appl. No.: 18/671,687

(22) Filed: May 22, 2024

Related U.S. Application Data
(60) Provisional application No. 63/503,505, filed on May 22, 2023.
(60) Provisional application No. 63/513,030, filed on Jul. 11, 2023.

(30) Foreign Application Priority Data
Jan. 18, 2022 (WO) PCT/IB2022/000018
Jan. 18, 2022 (WO) PCT/IB2022/000020

(51) Int. Cl. E04B 1/70; F26B 5/00; G01D 11/30; G01D 21/02

(52) U.S. Cl. CPC E04B 1/7007; F26B 5/00; G01D 11/305; G01D 21/02

(57) ABSTRACT

A system for reduction of moisture in porous materials is provided, including: a device for reducing moisture in porous materials including: an upper conductive board having a first side and a second side, one or more conductive track arranged in a spiral on the first side, and one or more conductive track arranged in a spiral on the second side; a lower conductive board having a first side, one or more conductive track arranged in a spiral on the first side; a conductive coupler extending from a radially inner core of the first side of the lower conductive board to a radially inner core of the second side of the upper conductive board; and at least one sensor oriented near the device, the sensor including a temperature and relative humidity probe and a moisture probe.

### CROSS-REFERENCE TO RELATED APPLICATIONS

This application claims the benefit of U.S. Provisional Patent Application No. 63/503,505, filed on May 22, 2023 and U.S. Provisional Patent Application No. 63/513,030, filed on Jul. 11, 2023. This application is also a continuation-in-part of PCT Patent Application No. PCT/IB2022/000018, filed on Jan. 18, 2022, which claims the benefit of U.S. Provisional Patent Application No. 63/296,140, filed on Jan. 3, 2022. This application is also a continuation-in-part of PCT Patent Application No. PCT/IB2022/000020, filed on Jan. 18, 2022, which claims the benefit of U.S. Provisional Patent Application No. 63/296,143, filed on Jan. 3, 2022. Each of these applications is incorporated by reference herein in its entirety.

### BACKGROUND

Porous materials, including for example, building materials such as concrete, cement, cinder blocks, bricks, mortar, and the like, often retain and/or allow the passage of moisture therein and/or therethrough. Moisture may enter these materials via rising damp which is the common term for the slow upward movement of moisture via capillary suction from the ground into lower parts of walls and other ground-supported structures. Alternatively, or additionally, moisture may initially enter these materials through the exposure of the materials to water from French drains, leaking pipes, runoff, springs, and the like. Subterranean portions of structures, such as basements, are the typical sites of these moisture issues.

Moisture in these materials can lead to degradation of the material itself (such as weakened mortar between bricks and cinder blocks) and rust or other corrosion of metal objects contained in the moist areas. Rust of metal structural items, such as beams, posts, joists, ties, and the like can lead to potentially dangerous degradation of the structural integrity of the structure due at least in part to the fact that the oxidized portion of metal can expand five to seven times in volume thereby cracking and weakening from within. Rust of metal items such as gas lines can lead to potentially dangerous gas leaks. Excess moisture in these materials fosters the growth of pathogens, including molds, viruses, and bacteria, that thrive in higher humidity indoor environments. See Institute of Medicine. 2004. Damp Indoor Spaces and Health. Washington, DC: The National Academies Press. Mold species that produce mycotoxins are especially dangerous for human health and, for some (e.g., the elderly and immunocompromised) can be fatal. See Baxi, S. N.; Portnoy, J. M.; Larenas-Linnemann, D.; Phipatanakul, W.; Barnes, C.; Baxi, S.; Grimes, C.; Horner, W. E.; Kennedy, K.; Larenas-Linnemann, D.; et al. “Exposure and Health Effects of Fungi on Humans.” J. Allergy Clin. Immunol. Pract. 2016, 4, 396-404. In vitro and in vivo studies have demonstrated adverse effects, including immunotoxic, neurologic, respiratory, and dermal responses, after exposure to specific toxins, bacteria, molds, or their products. Such studies have established that exposure to microbial toxins definitively occurs via inhalation. Yet, when moisture is controlled, pathogen growth is held in check and the concentration of pathogens remains sufficiently low and does not impact human health. See Verdier, T.; Coutand, M.; Bertron, A.; Roques, C. “A Review of Indoor Microbial Growth across Building Materials and Sampling and Analysis Methods.” Build. Environ. 2014, 80, 136-149. And finally, high moisture within enclosed subterranean areas is simply uncomfortable and unpleasant to individuals working or living in these areas.

The U.S. Department of Energy cites research that air conditioning accounts for nearly 20% of the global electricity used in buildings and a large portion of greenhouse gas emissions. Rising damp within buildings transforms ground water outside of the building into humid air inside of the building. It takes more energy to cool humid air because cooling energy is lost to evaporative drying. Studies have shown that in humid climates, over one half of electricity used in air conditioning does not cool, but rather dehumidifies, the building. As the primary source of excess building humidity is invasive groundwater, moisture remediation and/or mitigation inherently leads to more energy efficient air conditioning of the building.

Moisture remediation and/or mitigation can be effected by placement of a device for reduction of moisture in porous materials within the vicinity of the moisture infused wall. The device for reduction of moisture in porous materials may include an upper conductive board having three conductive tracks arranged in a spiral on each of a first and second side of the board, a lower conductive board having three conductive tracks arranged in a spiral on a first side of the board, and a conductive coupler extending from a radially inner core of the first side of the lower conductive board to a radially inner core of the second side of the upper conductive board.

However, efficient mechanisms do not exist for obtaining the baseline, or real-time, quantification of moisture in the moisture infused wall, followed by a real-time measurement of moisture in the moisture infused wall to confirm that the device for reduction of moisture in porous materials is functioning properly to reduce the moisture. For example, the position of the device may be too near a large metal object (e.g., a large metal cabinet) resulting in interference with the device's function and failure to reduce the moisture in the porous materials. This interference would not be known for some time (e.g., months) until regularly scheduled moisture measurements taken in situ demonstrated that moisture within the porous material was not being reduced as expected.

What is needed is a system and method for monitoring and using a device for reduction of moisture in porous materials.

### SUMMARY

In one aspect, a system for reduction of moisture in porous materials is provided, comprising: a device for reducing moisture in porous materials comprising: an upper conductive board comprising: a first side and a second side, one or more conductive track arranged in a spiral on the first side, and one or more conductive track arranged in a spiral on the second side; a lower conductive board comprising: a first side, one or more conductive track arranged in a spiral on the first side; a conductive coupler extending from a radially inner core of the first side of the lower conductive board to a radially inner core of the second side of the upper conductive board; and at least one sensor oriented near the device, the sensor including a temperature and relative humidity probe and a moisture probe.

In one aspect, a method for reduction of moisture in porous materials is provided, comprising: providing a device for reducing moisture in porous materials comprising: an upper conductive board comprising: a first side and a second side, one or more conductive track arranged in a spiral on the first side, and one or more conductive track arranged in a spiral on the second side; a lower conductive board comprising: a first side, one or more conductive track arranged in a spiral on the first side; a conductive coupler extending from a radially inner core of the first side of the lower conductive board to a radially inner core of the second side of the upper conductive board; and providing at least one sensor oriented near the device, the sensor including a temperature and relative humidity probe and a moisture probe, wherein the sensor collects temperature data, relative humidity data, and moisture data in a porous vertical structure.

### BRIEF DESCRIPTION OF THE FIGURES

The accompanying figures, which are incorporated in and constitute a part of the specification, illustrate various example systems and apparatuses, and are used merely to illustrate various example embodiments. In the figures, like elements bear like reference numerals.

FIG. 1A illustrates a top perspective view of a device 100 for reduction of moisture in porous materials.

FIG. 1B illustrates a bottom perspective view of device 100 for reduction of moisture in porous materials.

FIG. 1C illustrates a top perspective view of device 100 with an upper case portion 102 and a lower case portion 104 separated to permit viewing of the conductive boards 108, 110 contained within device 100.

FIG. 1D illustrates a top perspective view of device 100 with upper case portion 102 removed to permit viewing of conductive boards 108, 110 contained within device 100.

FIG. 1E illustrates an exploded top perspective view of device 100 with upper case portion 102 removed to permit viewing of conductive boards 108, 110 contained within device 100.

FIG. 1F illustrates an exploded bottom perspective view of device 100 with upper case portion 102 removed to permit viewing of conductive boards 108, 110 contained within device 100.

FIG. 1G illustrates a sectional view of device 100 to permit viewing of conductive boards 108, 110 contained within device 100.

FIG. 1H illustrates a sectional view of device 100 to permit viewing of conductive boards 108, 110 contained within device 100.

FIG. 2A illustrates an exploded top perspective view of a device 200 for reduction of moisture in porous materials.

FIG. 2B illustrates an exploded bottom perspective view of device 200.

FIG. 3A illustrates a sectional view of a device 300 for reduction of moisture in porous materials.

FIG. 3B illustrates a plan view of device 300.

FIG. 3C illustrates a plan view of device 300 with an upper case portion removed.

FIG. 4 illustrates a graph demonstrating internal wall moisture evolution within a building's walls after the installation of a device for reduction of moisture in porous materials within the building.

FIG. 5A illustrates a top perspective view of a device 500 for reduction of moisture in porous materials.

FIG. 5B illustrates a bottom perspective view of device 500 for reduction of moisture in porous materials.

FIG. 5C illustrates a top perspective view of device 500 with an upper case portion 502 and a lower case portion 504 separated to permit viewing of a conductive board 508 and coils 530, 532 contained within device 500.

FIG. 5D illustrates a top perspective view of device 500 with an upper case portion 502 and a lower case portion 504 separated to permit viewing of conductive board 508 and coils 530, 532 contained within device 500.

FIG. 5E illustrates a top perspective view of device 500 having conductive board 508 and coils 530, 532.

FIG. 5F illustrates a top perspective view of device 500 having conductive board 508 and coils 530, 532.

FIG. 5G illustrates a top perspective view of device 500 having coils 530, 532.

FIG. 5H illustrates a bottom perspective view of device 500 having conductive board 508 and coils 530, 532.

FIG. 5I illustrates a bottom perspective view of device 500 having conductive board 508 and coils 530, 532.

FIG. 5J illustrates a top perspective view of device 500 having conductive board 508 and coils 530, 532.

FIG. 6A illustrates a bottom perspective view of a device 600 for reduction of moisture in porous materials.

FIG. 6B illustrates a bottom perspective view of device 600.

FIG. 7A illustrates a sectional view of a device 700 for reduction of moisture in porous materials.

FIG. 7B illustrates a plan view of device 700.

FIG. 7C illustrates a plan view of device 700 with an upper case portion removed.

FIG. 8 illustrates a graph demonstrating internal wall moisture evolution within a building's walls after the installation of a device for reduction of moisture in porous materials within the building.

FIG. 9A illustrates a graph demonstrating internal wall % relative humidity over time in an unremediated state.

FIG. 9B illustrates a graph demonstrating internal wall % relative humidity over time in an unremediated state.

FIG. 9C illustrates a graph demonstrating internal wall % relative humidity over time in a remediated state.

FIG. 9D illustrates a graph demonstrating internal wall % relative humidity over time in a remediated state.

FIG. 9E illustrates a graph demonstrating internal wall absolute humidity over time both before and after application of a device for reduction of moisture in porous materials.

FIG. 10A illustrates an elevation view of a system 1030 including a sensor array 1040 applied to a wall 1036 in the presence of device 100, 200, 300, 500, 600, 700.

FIG. 10B illustrates a perspective view of system 1030 including sensor array 1040 applied to wall 1036 in the presence of device 100, 200, 300, 500, 600, 700.

FIG. 10C illustrates a perspective view of system 1030 including sensor array 1040 applied to wall 1036 in the presence of device 100, 200, 300, 500, 600, 700.

FIG. 10D illustrates an elevation view of sensor array 1040.

FIG. 10E illustrates a partial elevation view of sensor array 1040.

FIG. 10F illustrates a rear perspective view of sensor array 1040.

FIG. 10G illustrates a partial sectional view of sensor array 1040.

FIG. 10H illustrates a partial perspective view of sensor array 1040 applied to wall 1036.

FIG. 10I illustrates a partial perspective view of sensor array 1040 applied to wall 1036.

FIG. 10J illustrates a perspective view of sensor array 1040.

FIG. 10K illustrates a rear perspective view of sensor array 1040.

FIG. 11A illustrates a perspective view of a system 1130 including a sensor array 1140 applied to a wall 1136 in the presence of device 100, 200, 300, 500, 600, 700.

FIG. 11B illustrates a partial perspective view of sensor array 1140 applied to wall 1136.

FIG. 12 illustrates a partial perspective view of a sensor array 1240 applied to a wall 1236.

FIG. 13 illustrates a partial perspective view of sensor array 1340 applied to a wall 1336.

### DETAILED DESCRIPTION

### First Device Arrangement

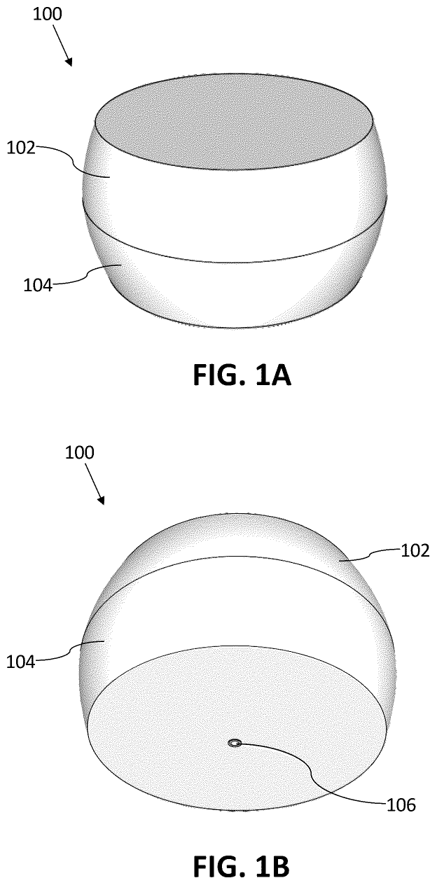

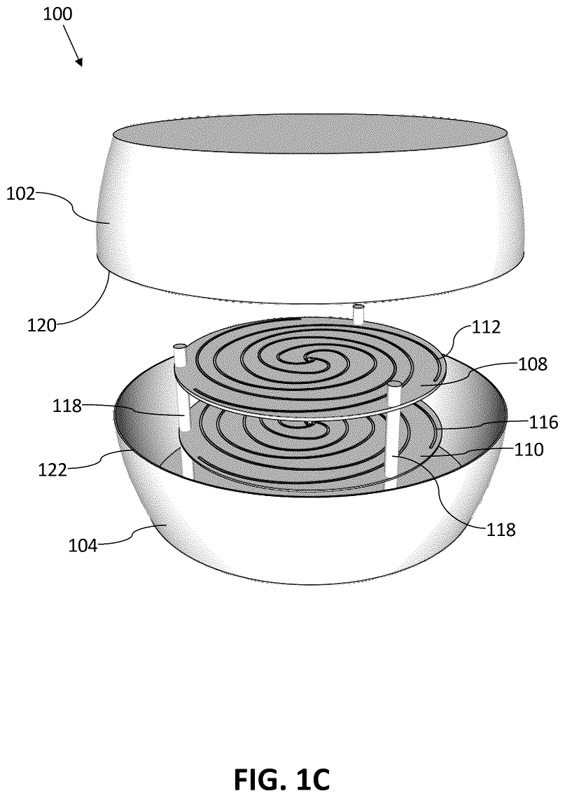

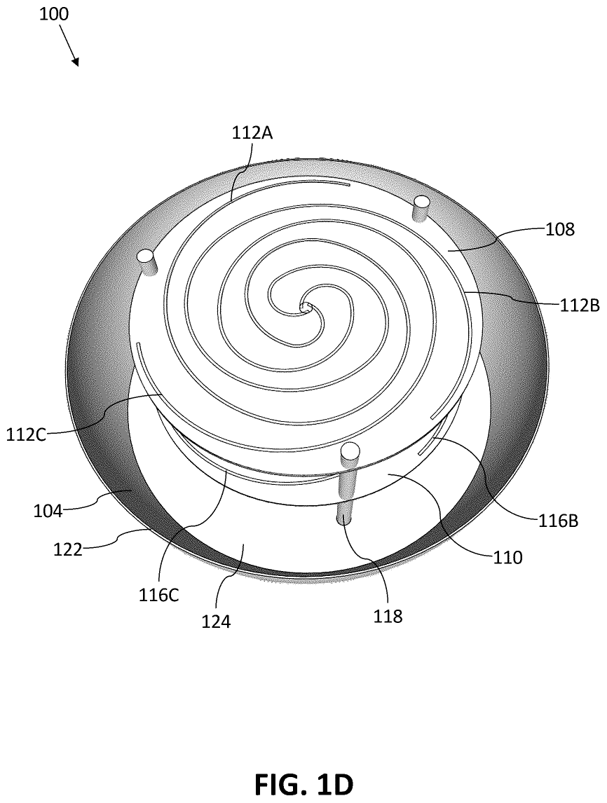

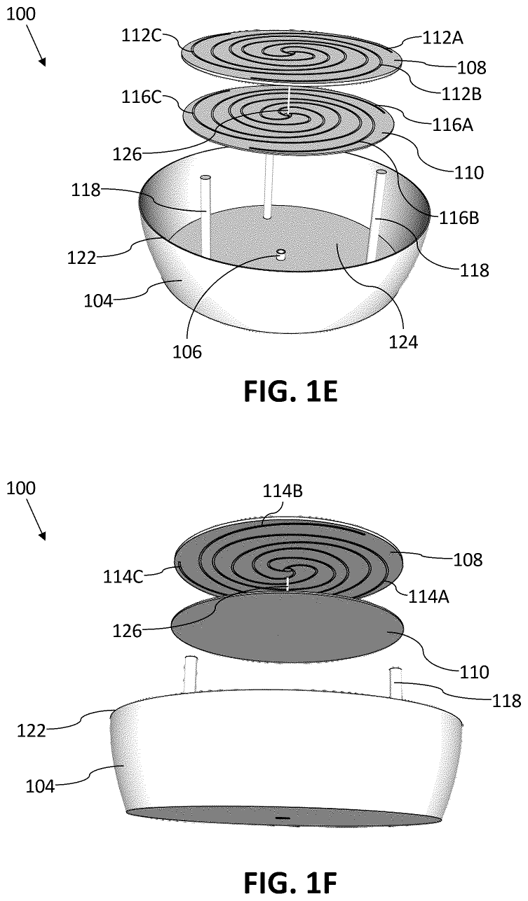

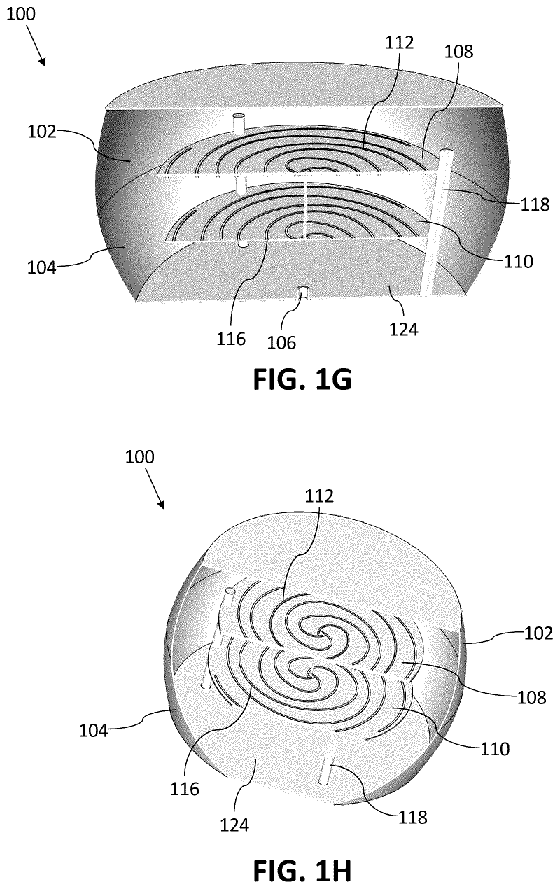

FIG. 1A-1H illustrate a device 100 for reduction of moisture in porous materials. Device 100 may include an upper case portion 102 and a lower case portion 104.

Upper case portion 102 may include a lower edge 120. Lower case portion 104 may include an upper edge 122. Lower edge 120 and upper edge 122 may be configured to mate with one another to form a total enclosure around the interior contents of device 100. Lower case portion 104 may include a base 124 to which at least some of the interior contents of device 100 may be mounted. Upper case portion 102 and lower case portion 104 may be formed from any of a variety of materials, including for example a metal, a polymer, a composite, and the like. Upper case portion 102 and lower case portion 104 may be formed from aluminum. Upper case portion 102 and lower case portion 104 may be coated in an anti-static paint. Upper case portion 102 and lower case portion 104 may be electrically connected to one another and electrically grounded.

Device 100 may include a fastening aperture 106 on base 124 to permit a user to mount device 100 to a ceiling, wall, post, floor, beam, or the like. Fastening aperture 106 may be a threaded boss fixed to base 124. Fastening aperture 106 may be a hole to permit passage of a bolt, screw, nail, or other fastener from within the interior of device 100.

Device 100 may include elements within upper case portion 102 and lower case portion 104. These elements may include an upper conductive board 108 and a lower conductive board 110. Upper conductive board 108 and lower conductive board 110 may be substantially parallel to one another. Upper conductive board 108 and lower conductive board 110 may be fixed to base 124 of lower case portion 104, and relative to one another, by one or more supporting element 118. Conductive board 108, 110 may be round, and one or more supporting element 118 may be oriented at or near the radially outer sides of conductive board 108, 110. One or more supporting element 118 may be made from any of a variety of materials, including for example a metal, a polymer, a composite, and the like. One or more supporting element 118 may be formed from an electrically non-conductive and/or insulative material such as a polymer.

Upper conductive board 108 may include one or more conductive track 112. Upper conductive board 108 may include a plurality of separate conductive tracks 112. Upper conductive board 108 may include one or more separate conductive tracks 112, 114 on a first (top) side and a second (bottom) side opposite to the first side. Upper conductive board 108 may include three conductive tracks 112A-112C on a first (top) side, and three conductive tracks 114A-114C on a second (bottom) side opposite to the first side. Upper conductive board 108 may include more than three conductive tracks 112, 114, including for example four, five, six, or more conductive tracks 112, 114.

Conductive tracks 112A-112C may extend in a clockwise direction from a radially inner portion of board 108 to a radially outer portion of board 108 on the first (top) side. Conductive tracks 114A-114C may extend in a counterclockwise direction from a radially inner portion of board 108 to a radially outer portion of board 108 on the second (bottom) side. Conductive tracks 112A-112C and 114A-114C may extend in opposite directions from one another. Conductive tracks 112A-112C and 114A-114C may extend from a radially inner core portion of board 108 in a spiral shape with an increasing radius until its termination at or near a radially outer portion of board 108.

Upper board 108 may be a printed circuit board. Conductive tracks 112, 114 may be made from an electrically conductive material, including for example, a metal such as silver, gold, or copper.

Conductive tracks 112A-112C may be electrically connected to one another at a radially inner core portion of board 108. Conductive tracks 114A-114C may be electrically connected to one another at a radially inner core portion of board 108. Conductive tracks 112A-112C may be electrically insulated from one another at a radially inner portion of board 108. Conductive tracks 114A-114C may be electrically insulated from one another at a radially inner portion of board 108.

Lower conductive board 110 may include one or more conductive track 116. Lower conductive board 110 may include a plurality of separate conductive tracks 116. Lower conductive board 110 may include one or more separate conductive tracks 116 on a first (top) side and a second (bottom) side opposite to the first side. Lower conductive board 110 may include three conductive tracks 116A-116C on a first (top) side, and no conductive tracks on a second (bottom) side opposite to the first side.

Conductive tracks 116A-116C may extend in a clockwise direction from a radially inner portion of board 110 to a radially outer portion of board 110 on the first (top) side. Conductive tracks 116A-116C and 112A-112C may extend in the same direction as one another. Conductive tracks 116A-116C may extend in a direction opposite that of conductive tracks 114A-114C. Conductive tracks 116A-116C may extend from a radially inner core portion of board 110 in a spiral shape with an increasing radius until its termination at or near a radially outer portion of board 110.

Lower board 110 may be a printed circuit board. Conductive track 116 may be made from an electrically conductive material, including for example, a metal such as silver, gold, or copper.

Conductive tracks 116A-116C may be electrically connected to one another at a radially inner portion of board 110. Conductive tracks 116A-116C may be electrically insulated from one another at a radially inner portion of board 110.

Upper conductive board 108 and lower conductive board 110 may be connected by a conductive coupler 126. Conductive coupler 126 may be made from an electrically conductive material, including for example, a metal such as silver, gold, or copper. Conductive coupler 126 may extend from a radially inner core of a first (top) side of lower conductive board 110 to a radially inner core of a second (bottom) side of upper conductive board 108. The radially inner core of the second (bottom) side of upper conductive board 108 may be electrically connected to the radially inner core of the first (top) side of upper conductive board 108.

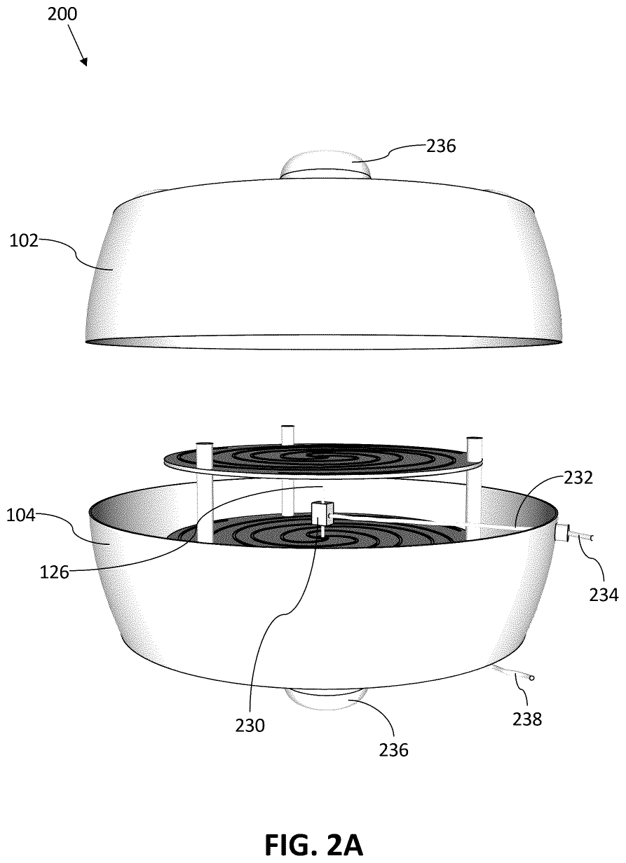

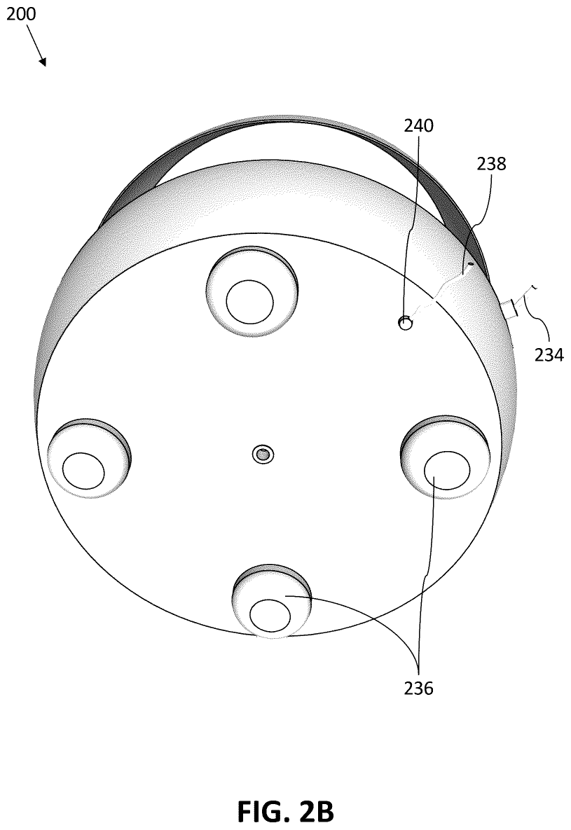

FIGS. 2A and 2B illustrate a device 200 for reduction of moisture in porous materials. Device 200 may include an upper case portion 102 and a lower case portion 104.

An upper conductive board and a lower conductive board may be connected by a conductive coupler 126. Conductive coupler 126 may be made from an electrically conductive material, including for example, a metal such as silver, gold, or copper. Conductive coupler 126 may include a terminal 230 connected to a switch 234 via a wire 232, configured to selectively “break” or “open” conductive coupler 126 to prevent the flow of electricity or other energy through conductive coupler 126. Switch 234 may likewise selectively “close” conductive coupler 126 to allow the flow of electricity or other energy through conductive coupler 126. Switch 234 may be oriented on the exterior of one of upper case portion 102 or lower case portion 104 to permit a user to manipulate the flow of electricity or other energy through conductive coupler 126 from the outside of device 200 when device 200 is assembled and/or installed.

Device 200 may include one or more protective bumper 236 on one or both of upper case portion 102 and lower case portion 104. Bumpers 236 may be a rubber, polymer, metal, or the like, and designed to prevent damage (e.g., dents, cracks, scrapes, and scratches) to one or both of upper case portion 102 and lower case portion 104.

Device 200 may include a grounding element 238 connected to one or both of upper case portion 102 and lower case portion 104. Grounding element 238 may be connected to one or both of upper case portion 102 and lower case portion 104 via an electrically conductive stud 240. Grounding element 238 may be a wire or other conductor capable of carrying an electrical current to ground device 200.

Upper case portion 102, lower case portion 104, upper conductive board 108, and lower conductive board 110, in each of FIGS. 1A-1H and FIGS. 2A-2B are illustrated as being round/circular in shape. It is contemplated that any of these elements may have any of a variety of alternative shapes, including for example, square, hexagonal, and the like.

It is contemplated that in either of devices 100 or 200, a non-conductive liner could be placed upon the interior walls of one or both of upper case portion 102 and lower case portion 104. This liner may act as padding to prevent damage to internal components of devices 100 or 200 should those internal components become loose within upper case portion 102 and/or lower case portion 104.

### Example

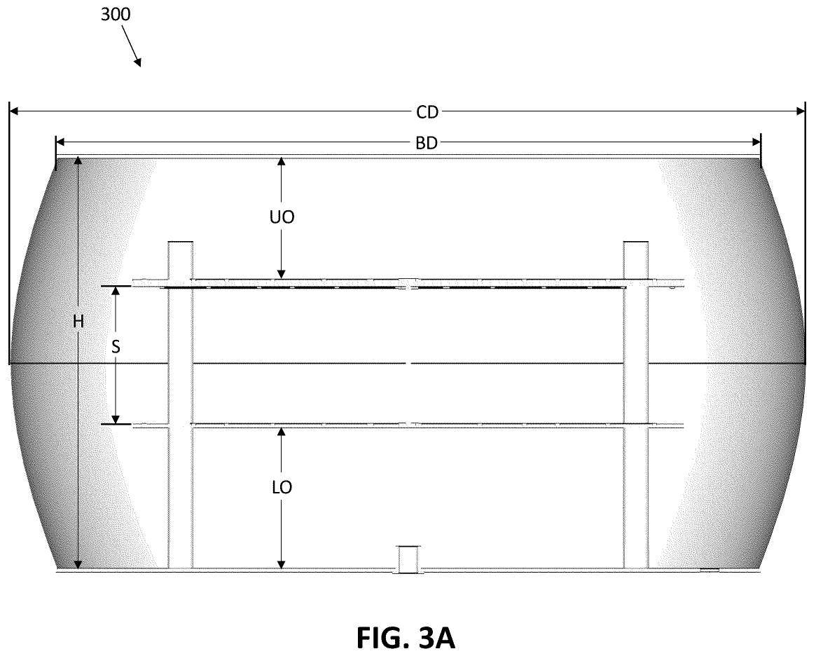

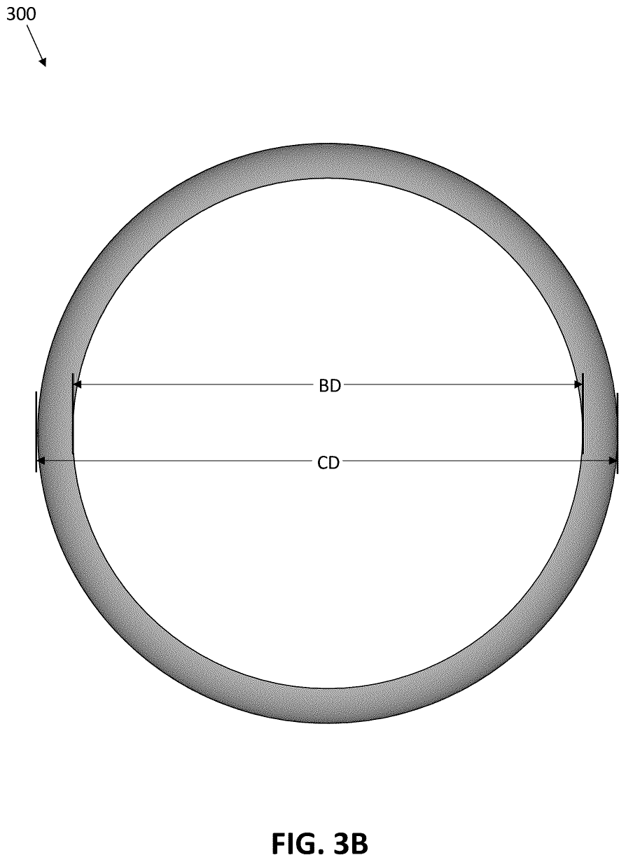

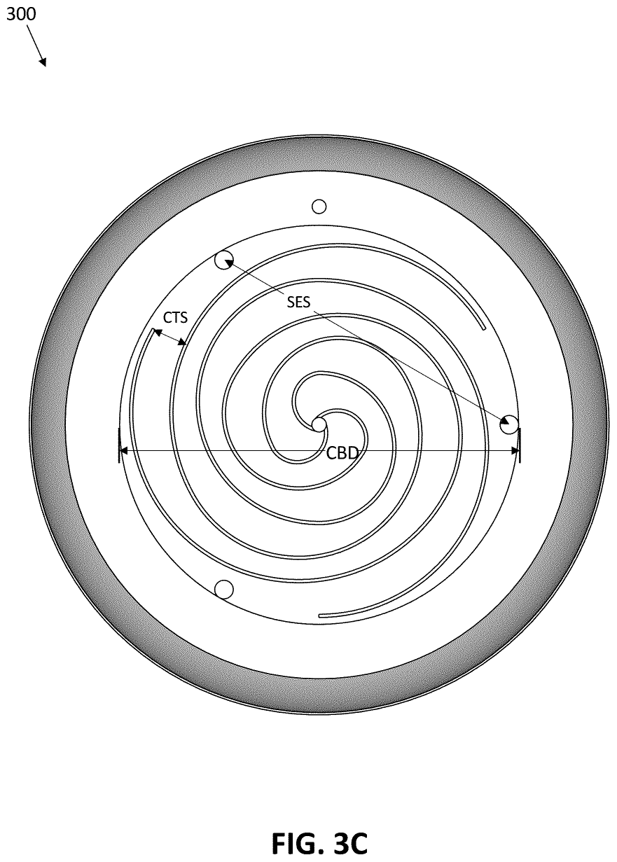

FIG. 3A-3C illustrate a device 300 for reduction of moisture in porous materials. In one example arrangement, device 300's combined upper and lower case portions have a central diameter CD of about 323.85 mm. Device 300's upper and lower case portions have base diameters BD (at their extreme upper and lower surfaces, respectively) of about 276.23 mm. Device 300's combined upper and lower case portions have a height H of about 165.10 mm.

Device 300's upper conduct board and lower conductive board are separated by a spacing S of about 50.80 mm. Device 300's upper conductive board includes an upper offset UO from the extreme upper surface of the upper case portion of about 50.80 mm. Device 300's lower conductive board includes a lower offset LO from the extreme lower surface of the lower case portion of about 50.80 mm.

Device 300's upper and lower conductive boards have a conductive board diameter CBD of about 220.67 mm. Device 300's conductive tracks may have a radially outer conductive track spacing CTS of about 15.88 mm. Device 300's supporting elements may be separated by a supporting element spacing SES of about 180.98 mm.

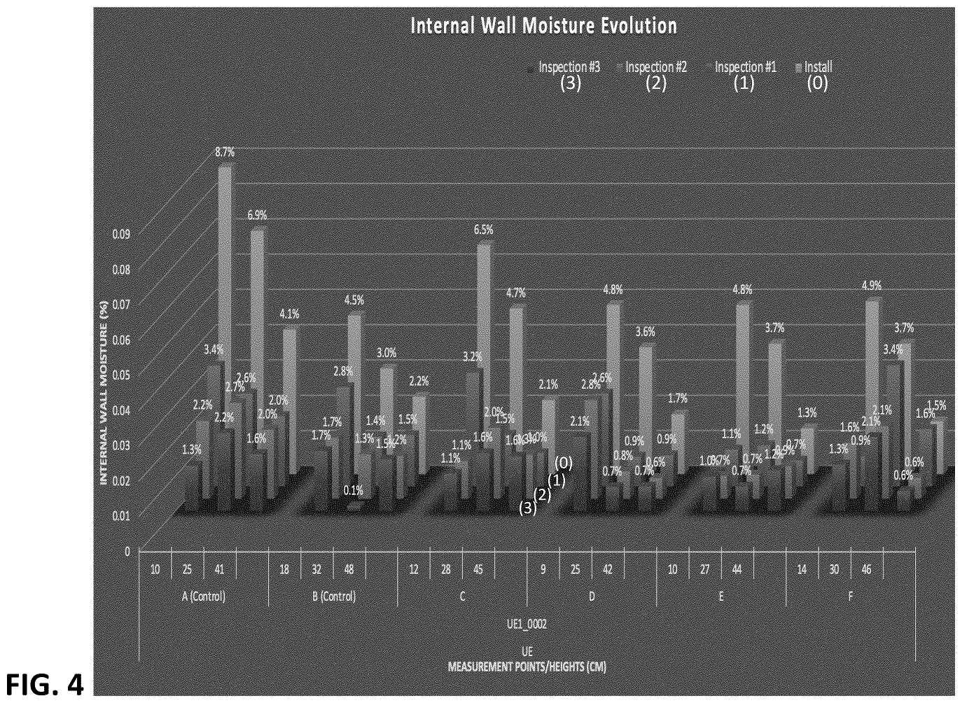

FIG. 4 illustrates a graph demonstrating internal wall moisture evolution within a building's walls after the installation of a device for reduction of moisture in porous materials within the building. FIG. 4 shows results taken from various points in various walls of a building over time. A device for reduction of moisture in porous materials, such as any of devices 100, 200, or 300, was installed within the perimeter of a building's walls.

Initial internal wall moisture values (%) were determined at the time of installation of the device at points A-F; these values are illustrated in the rearmost row of bars illustrated in FIG. 4, and identified as (0). At each of points A-F, internal wall moisture values were determined at three different heights (cm). For example, at point A, internal wall moisture values were determined at 10 cm, 25 cm, and 41 cm from the floor.

After the installation of the device at points A-F, three inspections identified as (1), (2), and (3) were performed, in which internal wall moisture values were determined at points A-F, at the aforementioned three different heights. First inspection (1) values are illustrated in the row just in front of installation (0) values, second inspection (2) values are illustrated in the row just in front of first inspection (1) values, and third inspection (3) values are illustrated in the frontmost row just in front of second inspection (2) values.

As illustrated in FIG. 4, the internal wall moisture values consistently decreased from installation (0) values through third inspection (3) values.

### Second Device Arrangement

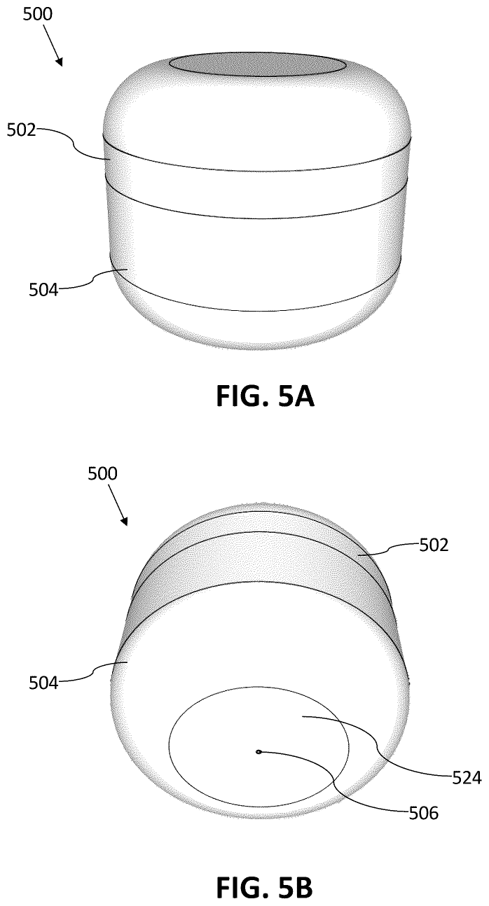

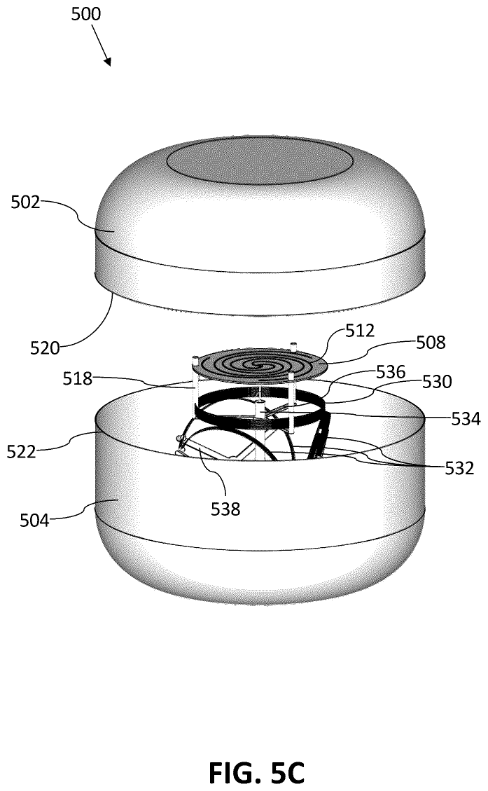

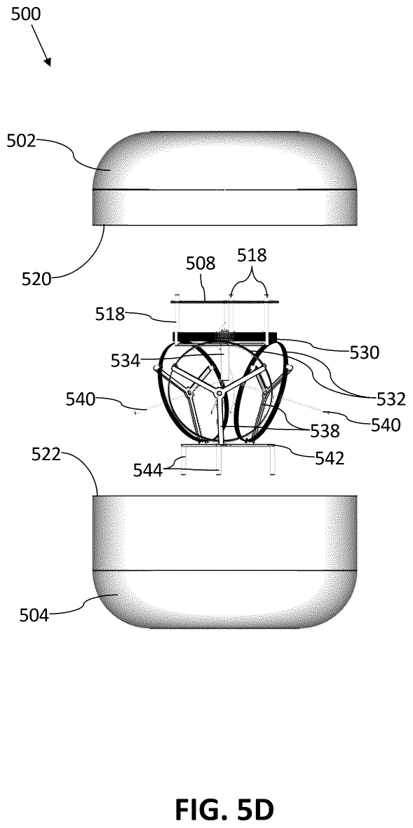

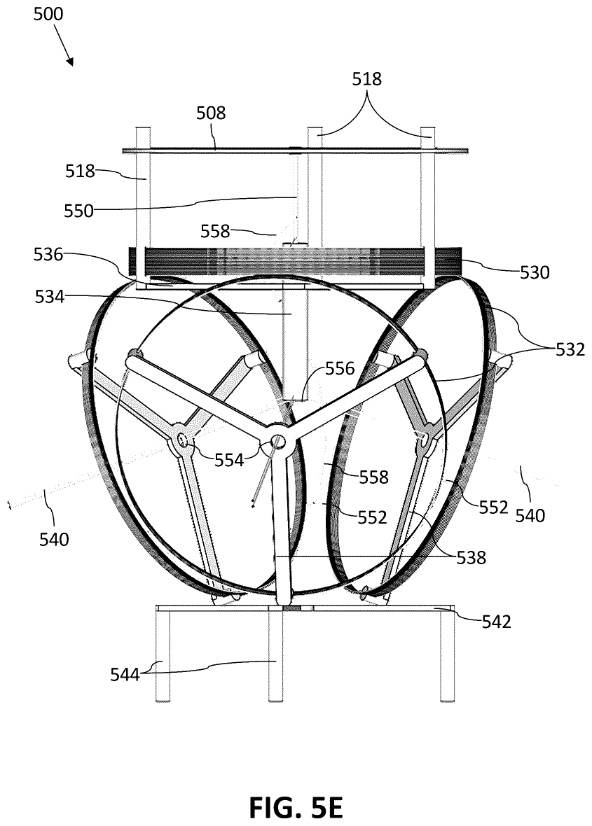

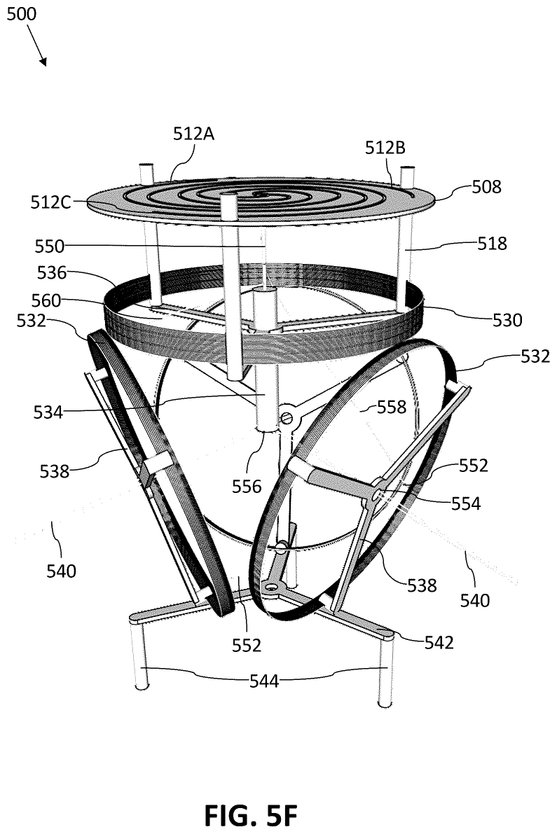

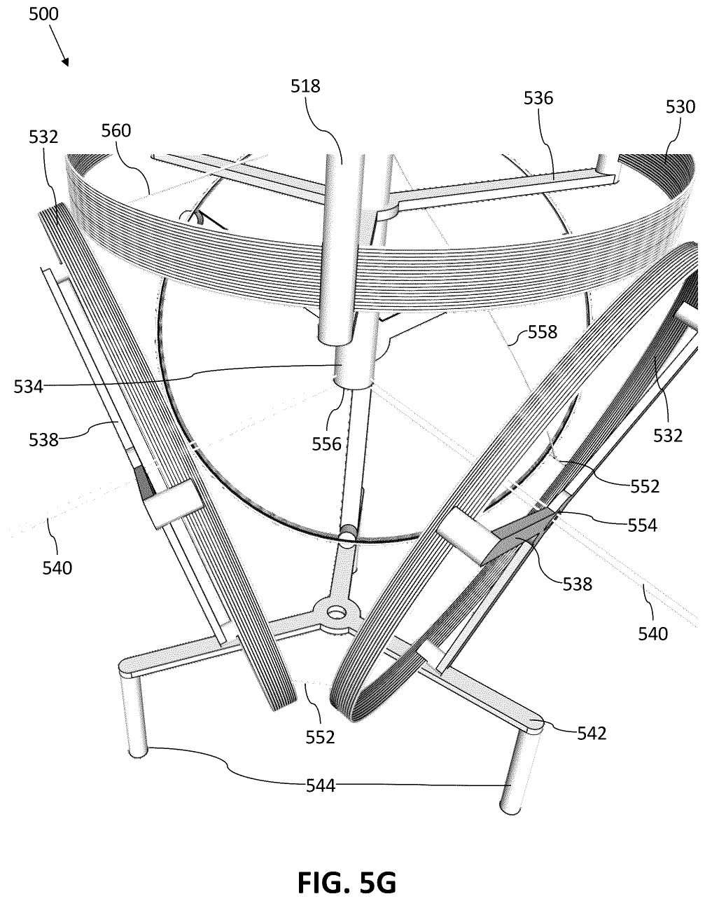

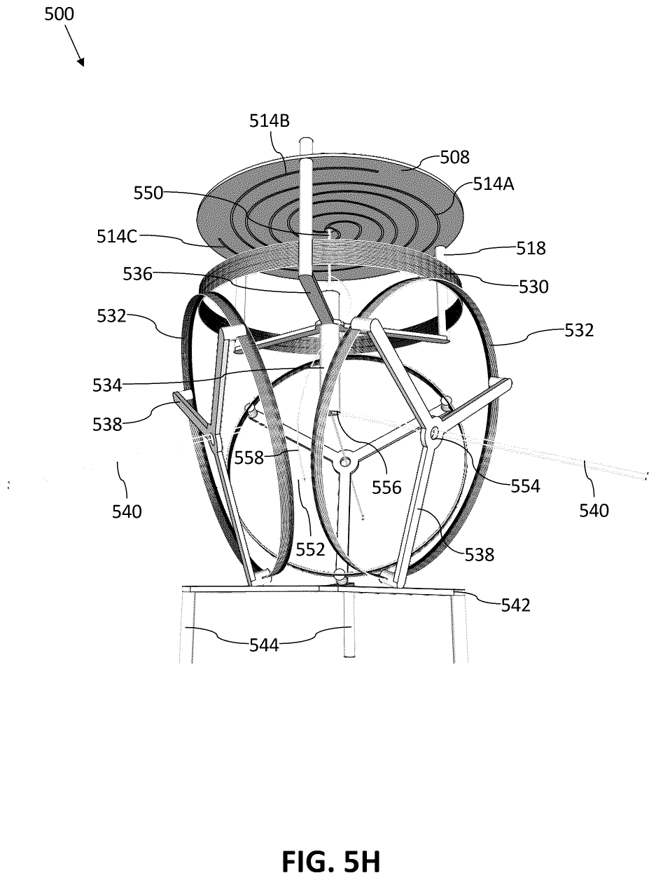

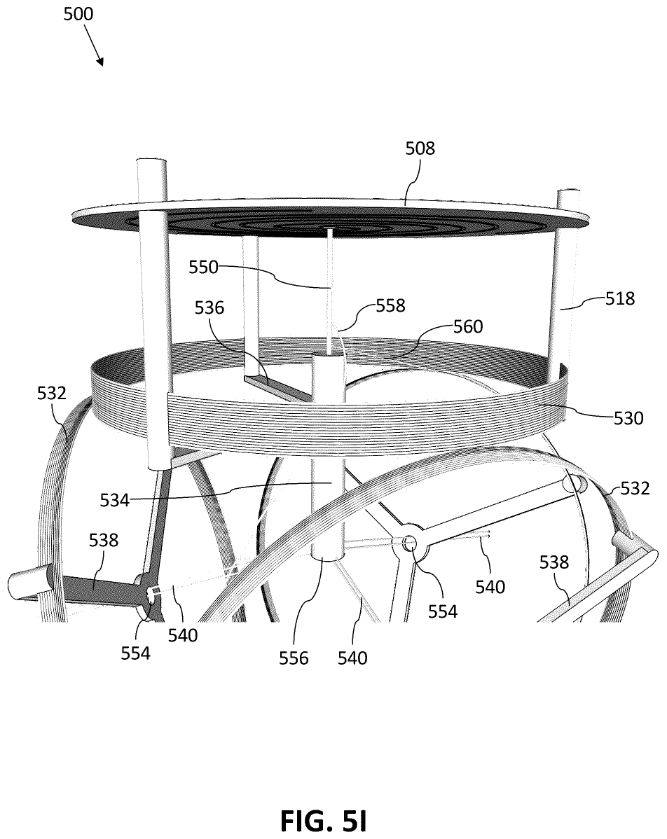

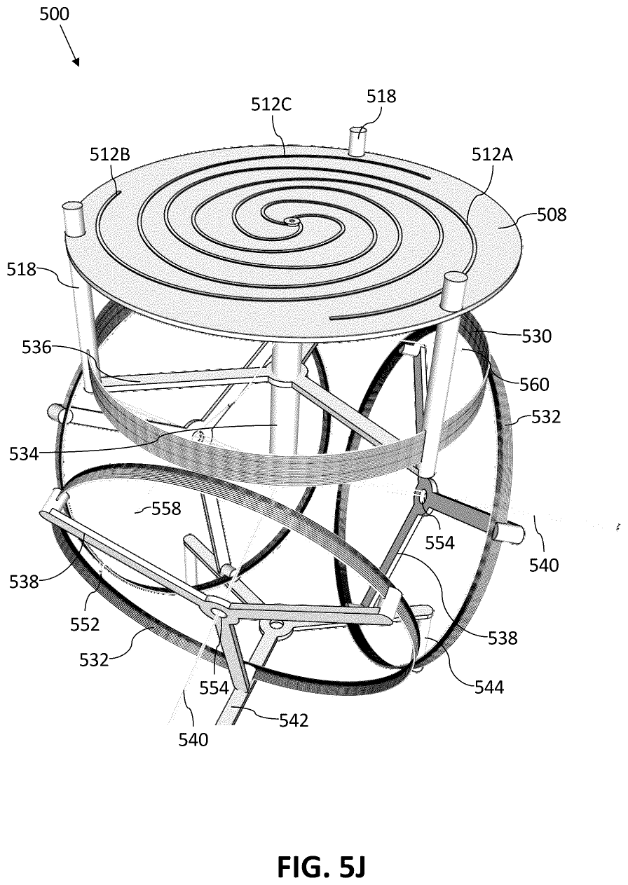

FIG. 5A-1J illustrate a device 500 for reduction of moisture in porous materials. Device 500 may include an upper case portion 502 and a lower case portion 504.

Upper case portion 502 may include a lower edge 520. Lower case portion 504 may include an upper edge 522. Lower edge 520 and upper edge 522 may be configured to mate with one another to form a total enclosure around the interior contents of device 500. Lower case portion 504 may include a base 524 to which at least some of the interior contents of device 500 may be mounted. Upper case portion 502 and lower case portion 504 may be formed from any of a variety of materials, including for example a metal, a polymer, a composite, and the like. Upper case portion 502 and lower case portion 504 may be formed from aluminum. Upper case portion 502 and lower case portion 504 may be coated in an anti-static paint. Upper case portion 502 and lower case portion 504 may be electrically connected to one another and electrically grounded.

Device 500 may include a fastening aperture 506 on base 524 to permit a user to mount device 500 to a ceiling, wall, post, floor, beam, or the like. Fastening aperture 506 may be a threaded boss fixed to base 524. Fastening aperture 506 may be a hole to permit passage of a bolt, screw, nail, or other fastener from within the interior of device 500. Device 500 may include a threaded rod extending from fastening aperture 506 to aid in handling and/or installation of device 500. That is, the threaded rod may be used to mount device 500 to a structure.

Device 500 may include elements within upper case portion 502 and lower case portion 504. These elements may include a conductive board 508. Conductive board 508 may be fixed to base 524 of lower case portion 504 through a series of other elements as described below. Conductive board 508, 510 may be round, and one or more supporting element 518 may be oriented at or near the radially outer sides of conductive board 508. One or more supporting element 518 may be made from any of a variety of materials, including for example a metal, a polymer, a composite, and the like. One or more supporting element 518 may be formed from an electrically non-conductive and/or insulative material such as a polymer.

Conductive board 508 may include one or more conductive track 512. Conductive board 508 may include a plurality of separate conductive tracks 512. Conductive board 508 may include one or more separate conductive tracks 512, 514 on a first (top) side and a second (bottom) side opposite to the first side. Conductive board 508 may include three conductive tracks 512A-512C on a first (top) side, and three conductive tracks 514A-514C on a second (bottom) side opposite to the first side. Conductive board 508 may include more than three conductive tracks 512, 514, including for example four, five, six, or more conductive tracks 512, 514.

Conductive tracks 512A-512C may extend in a clockwise direction from a radially inner portion of board 508 to a radially outer portion of board 508 on the first (top) side. Conductive tracks 514A-514C may extend in a counterclockwise direction from a radially inner portion of board 508 to a radially outer portion of board 508 on the second (bottom) side. Conductive tracks 512A-512C and 514A-514C may extend in opposite directions from one another. Conductive tracks 512A-512C and 514A-514C may extend from a radially inner core portion of board 508 in a spiral shape with an increasing radius until its termination at or near a radially outer portion of board 508.

Conductive board 508 may be a printed circuit board. Conductive tracks 512, 514 may be made from an electrically conductive material, including for example, a metal such as silver, gold, or copper.

Conductive tracks 512A-512C may be electrically connected to one another at a radially inner core portion of board 508. Conductive tracks 514A-514C may be electrically connected to one another at a radially inner core portion of board 508. Conductive tracks 512A-512C may be electrically insulated from one another at a radially inner portion of board 508. Conductive tracks 514A-514C may be electrically insulated from one another at a radially inner portion of board 508.

One or more supporting element 518 may connect at one end to conductive board 508, and at another end to a primary coil 530. Primary coil 530 may be a coil of wire formed from a conductive material, including for example, silver, gold, or copper. Primary coil 530 may be substantially parallel to conductive board 508. Primary coil 530 may be oriented below conductive board 508. One or more supporting element 518 may additionally connect to a primary coil frame member 536. Frame member 536 may include a plurality of arms and a central aperture. The arms may extend to and connect to one or both of primary coil 530 and one or more supporting element 518. Frame member 536 may be made from any of a variety of materials, including for example a metal, a polymer, a composite, and the like. Frame member 536 may be formed from an electrically non-conductive and/or insulative material such as a polymer.

Device 500 may contain a conductive hub 534 oriented within the perimeter of primary coil 530. Conductive hub 534 may extend through and engage the central aperture of primary coil frame member 536. Conductive hub 534 may be cylindrical in shape, and may be oriented along an axis that is normal to conductive board 508 and/or primary coil 530. Conductive hub 534 may be oriented along an axis that is parallel to or colinear with the axis about which primary coil 530 is coiled.

An upper end of conductive hub 534 may connect to the second (bottom) side of conductive board 508 by a conductive coupler 550. Conductive coupler 550 may be made from an electrically conductive material, including for example, a metal such as silver, gold, or copper. Conductive coupler 550 may extend from the top of conductive hub 534 to a radially inner core of a second (bottom) side of conductive board 508. The radially inner core of the second (bottom) side of conductive board 508 may be electrically connected to the radially inner core of the first (top) side of conductive board 508.

Device 500 may include a plurality of secondary coils 532. Each of secondary coils 532 may be a coil of wire formed from a conductive material, including for example, silver, gold, or copper. Each of secondary coils 532 may be connected to a secondary coil frame member 538. Frame members 538 may include a plurality of arms and a central aperture 554. Frame member 538 may be made from any of a variety of materials, including for example a metal, a polymer, a composite, and the like. Frame member 538 may be formed from an electrically non-conductive and/or insulative material such as a polymer.

Primary coil 530 may be connected directly to, and supported by, the plurality of secondary coils 532. In this manner, primary coil frame member 536, conductive hub 534, conductive coupler 550, and conductive board 508 are supported by the plurality of secondary coils 536.

Each of secondary coils 532 may be evenly distributed about a circle having an axis colinear with conductive hub 534. Each of secondary coils 532 may be oriented below primary coil 530 and conductive board 508. In one aspect, device 500 may include three secondary coils 532, and each of the three secondary coils 532 is oriented 120 degrees from the adjacent secondary coil 532 taken about an axis colinear with conductive hub 534. Each of secondary coils 532 may be inclined such that the axes about which secondary coils 532 are coiled forms an obtuse angle with the centerline of conductive hub 534 and/or the axis about which primary coil 530 is coiled. This obtuse angle may be between about 90 degrees and about 120 degrees.

In one aspect, device 500 may include more than three secondary coils 532. For example, device 500 may include four secondary coils 532, each oriented 90 degrees from the adjacent secondary coil 532 taken about an axis colinear with conductive hub 534. In another example, device 500 may include five secondary coils 532, each oriented 72 degrees from the adjacent secondary coil 532 taken about an axis colinear with conductive hub 534.

Through the center of each secondary coil 532 extends an elongated conductor 540. Elongated conductor 540 may be made from a conductive material, such as silver, gold, or copper. Elongated conductor 540 may include two parallel conductor wires. Each elongated conductor 540 may extend from (and electrically connect to) a lower portion 556 of conductive hub 534, through the center of secondary coil 532 and through central aperture 554, and toward lower case portion 504 and/or upper case portion 502 without physically contacting either of lower case portion 504 or upper case portion 502.

Each of secondary coils 532 may be electrically connected to adjacent secondary coils 532 via a secondary coil connector 552. Connector 552 may be made from a conductive material, such as silver, gold, or copper. In this manner, each of secondary coils 532 are electrically connected to one another.

At least one connector 552 is directly electrically connected to conductive coupler 550 and/or conductive hub 534 by a secondary coil main connector 558. Secondary coil main connector 558 may be made from a conductive material, such as silver, gold, or copper. In this manner, each secondary coil 532 is electrically connected to conductive coupler 550 and/or conductive hub 534.

Primary coil 530 is electrically connected to conductive coupler 550 and/or conductive hub 534 by a primary coil main connector 560. Primary coil main connector 560 may be made from a conductive material, such as silver, gold, or copper.

Frame members 538 may be oriented such that a single arm is oriented downwardly and connects to an arm of base frame member 542. Base frame member 542 may include a plurality of arms. One or more base support element 544 may extend from each of the plurality of arms to base 524. Base support elements 544 may be fastened to base 524. As each of the internal elements of device 500 are connected to one another, the connection of base support elements 544 to base 524 secures the entirety of the internal elements of device 500 to lower case portion 504. Base support elements 544 may be made from any of a variety of materials, including for example a metal, a polymer, a composite, and the like. One or more base support element 544 may be formed from an electrically non-conductive and/or insulative material such as a polymer. Base frame member 542 may be made from any of a variety of materials, including for example a metal, a polymer, a composite, and the like. Base frame member 542 may be formed from an electrically non-conductive and/or insulative material such as a polymer.

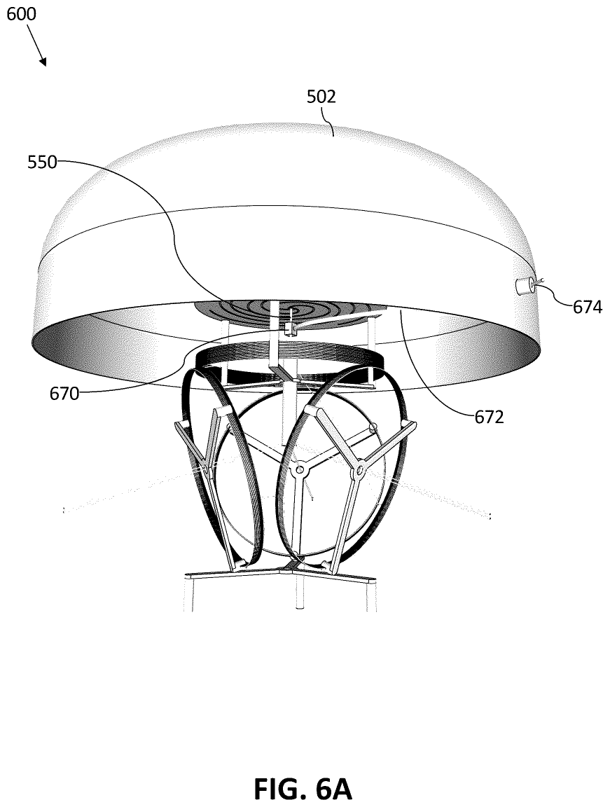

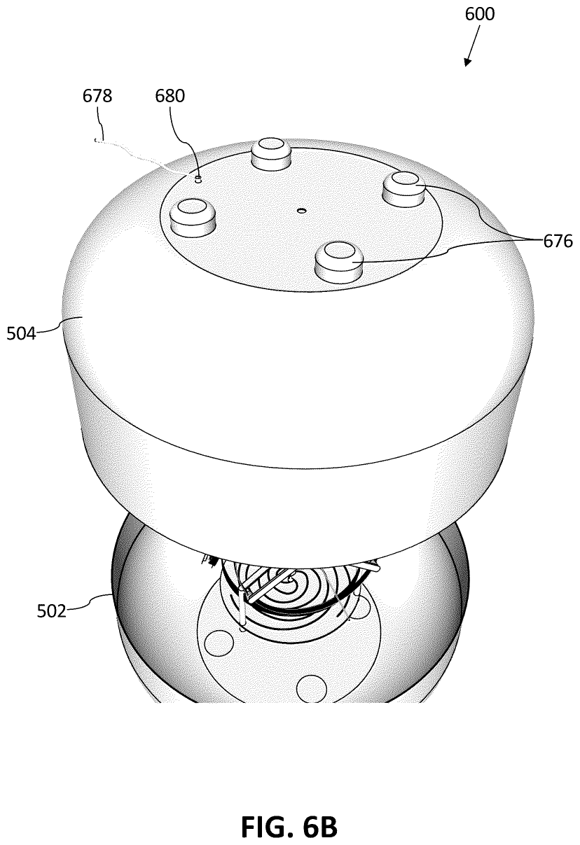

FIGS. 6A and 6B illustrate a device 600 for reduction of moisture in porous materials. Device 600 may include an upper case portion 502 and a lower case portion 504.

A conductive board and a conductive hub may be connected by a conductive coupler 550. Conductive coupler 550 may be made from an electrically conductive material, including for example, a metal such as silver, gold, or copper. Conductive coupler 550 may include a terminal 670 connected to a switch 674 via a wire 672, configured to selectively “break” or “open” conductive coupler 550 to prevent the flow of electricity or other energy through conductive coupler 550. Switch 674 may likewise selectively “close” conductive coupler 550 to allow the flow of electricity or other energy through conductive coupler 550. Switch 674 may be oriented on the exterior of one of upper case portion 502 or lower case portion 504 to permit a user to manipulate the flow of electricity or other energy through conductive coupler 550 from the outside of device 600 when device 600 is assembled and/or installed.

Device 600 may include one or more protective bumper 676 on one or both of upper case portion 502 and lower case portion 504. Bumpers 676 may be a rubber, polymer, metal, or the like, and designed to prevent damage (e.g., dents, cracks, scrapes, and scratches) to one or both of upper case portion 502 and lower case portion 504.

Device 600 may include a grounding element 678 connected to one or both of upper case portion 502 and lower case portion 504. Grounding element 678 may be connected to one or both of upper case portion 502 and lower case portion 504 via an electrically conductive stud 680. Grounding element 678 may be a wire or other conductor capable of carrying an electrical current to ground device 600.

Upper case portion 502, lower case portion 504, and conductive board 508, in each of FIGS. 5A-5J and FIGS. 6A-6B are illustrated as being round/circular in shape. It is contemplated that any of these elements may have any of a variety of alternative shapes, including for example, square, hexagonal, and the like.

It is contemplated that in either of devices 500 or 600, a non-conductive liner could be placed upon the interior walls of one or both of upper case portion 502 and lower case portion 504. This liner may act as padding to prevent damage to internal components of devices 500 or 600 should those internal components become loose within upper case portion 502 and/or lower case portion 504.

### Example

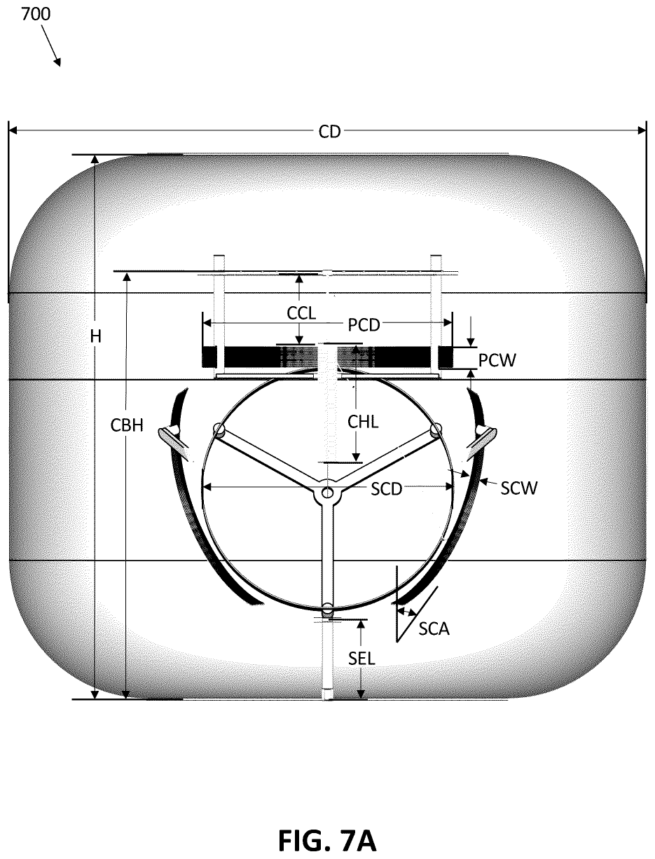

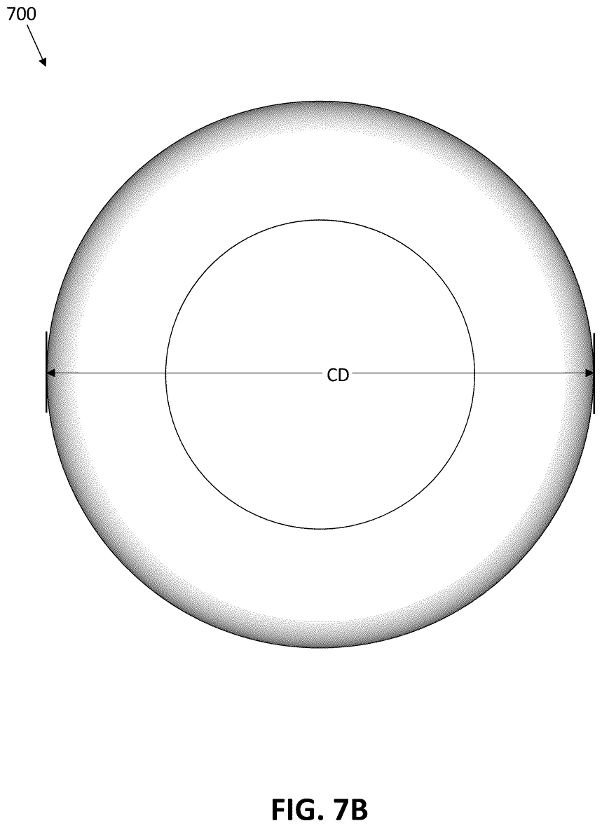

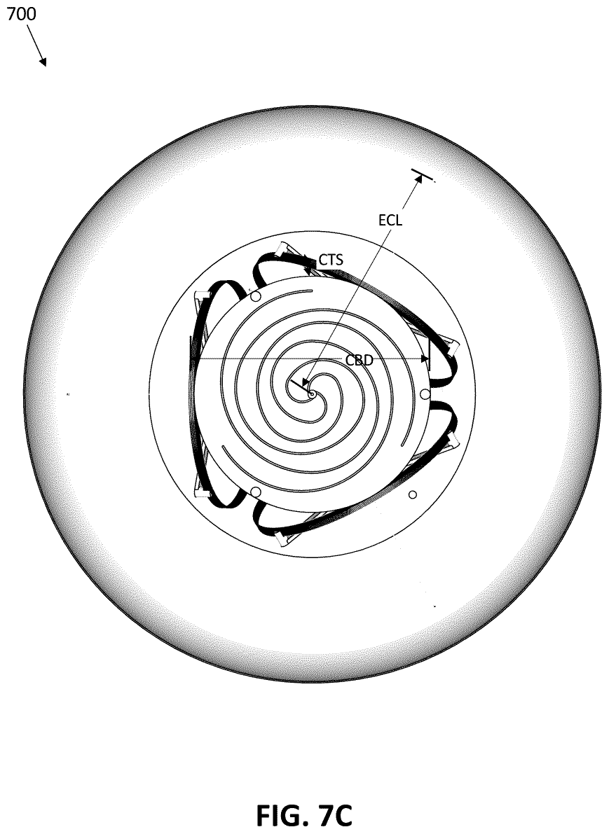

FIG. 7A-7C illustrate a device 700 for reduction of moisture in porous materials. In one example arrangement, device 700's combined upper and lower case portions have a central diameter CD of about 549.28 mm. Device 700's combined upper and lower case portions have a height H of about 479.43 mm.

Device 700's conductive board is oriented at a height CBH from the extreme lower surface of the lower case portion of about 355.60 mm. Device 700's conductive hub includes a length CHL of about 101.60 mm. Device 700's conductive coupler includes a length CCL of about 50.80 mm.

Device 700's primary coil includes a diameter PCD of about 215.90 mm and a width PCW of about 30.16 mm. Device 700's secondary coils include a diameter SCD of about 215.90 mm and a width SCW of about 15.88 mm. The secondary coils are oriented at an angle SCA of about 20 degrees relative to an axis parallel to the conductive hub and the conductive coupler. Device 700's base support elements have a length SEL of about 76.20 mm.

Device 700's conductive board has a conductive board diameter CBD of about 220.67 mm. Device 700's conductive tracks may have a radially outer conductive track spacing CTS of about 15.88 mm. Device 700's elongated coupler has a length ECL of about 228.60 mm.

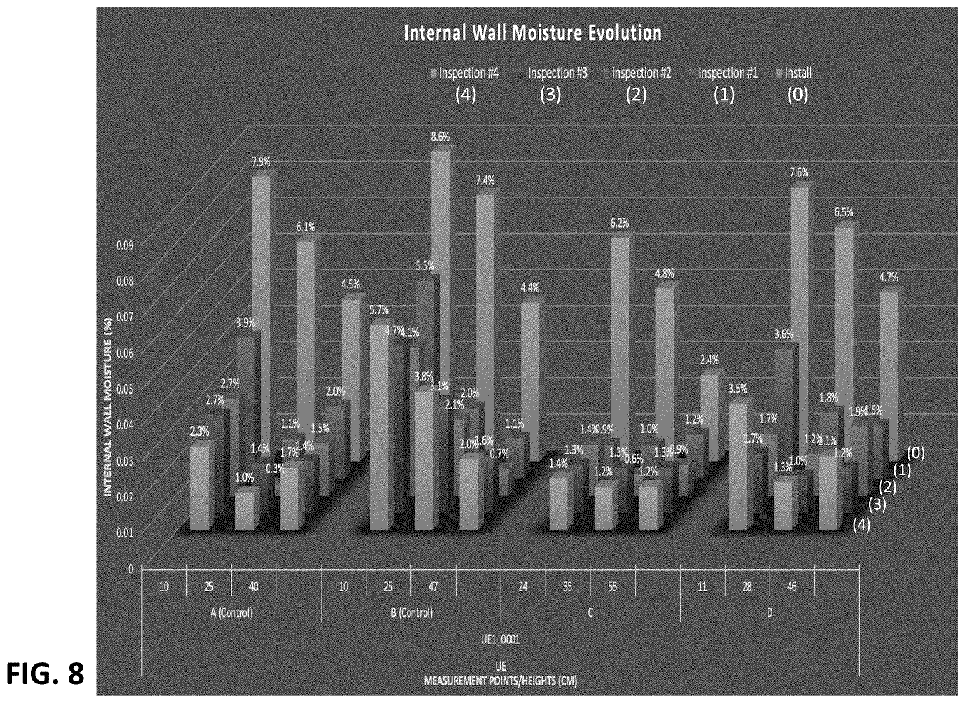

FIG. 8 illustrates a graph demonstrating internal wall moisture evolution within a building's walls after the installation of a related device for reduction of moisture in porous materials within the building. FIG. 8 shows results taken from various points in various walls of a building over time. A device for reduction of moisture in porous materials, such as any of devices 500, 600, or 700, was installed within the perimeter of a building's walls.

Initial internal wall moisture values (%) were determined at the time of installation of the device at points A-D; these values are illustrated in the rearmost row of bars illustrated in FIG. 8, and identified as (0). At each of points A-D, internal wall moisture values were determined at three different heights (cm). For example, at point A, internal wall moisture values were determined at 10 cm, 25 cm, and 40 cm from the floor.

After the installation of the device at points A-D, four inspections identified as (1), (2), (3), and (4) were performed, in which internal wall moisture values were determined at points A-D, at the aforementioned three different heights. First inspection (1) values are illustrated in the row just in front of installation (0) values, second inspection (2) values are illustrated in the row just in front of first inspection (1) values, third inspection (3) values are illustrated in the row just in front of second inspection (2) values, and fourth inspection (4) values are illustrated in the frontmost row just in front of third inspection (3) values.

As illustrated in FIG. 8, the internal wall moisture values generally decreased from installation (0) values through fourth inspection (4) values.

Device 100, 200, 300, 500, 600, 700 operates without electricity, battery, solar, or any conventional power source. Device 100, 200, 300, 500, 600, 700 is grounded like a spherical capacitor and can dry the first floor and/or basement sub-levels with a coverage diameter up to 300 ft. (91.44 m). Without wishing to be bound by theory, it is hypothesized that device 100, 200, 300, 500, 600, 700 operates like an antenna emitting radio frequencies, which has the effect of charging the ambient air with negative ions. It is hypothesized that device 100, 200, 300, 500, 600, 700 operates as a passive antenna. It is hypothesized that water is dried out of porous (e.g., masonry) walls and floors through the disruption of hydrogen-silica bonds within the porous walls and floors. The disruption of these bonds partially reverses the capillary effect of rising damp when device 100, 200, 300, 500, 600, 700 is installed within range of the porous walls and floors. It is hypothesized that the disruption of bonds is the result of the radio frequency emitted by device 100, 200, 300, 500, 600, 700, which interferes with the surface tension of the water on surfaces and/or the resonant frequency of hydrogen (1.42 GHZ). The result is the increase in negative ionization, which includes an ancillary positive effect on indoor air quality and the evaporation of surface water. However, a device whose structure is otherwise covered by the claims set forth herein, but that is hypothesized to work via a different mechanism, is intended to be covered by the scope of the invention.

### Device and Sensor System

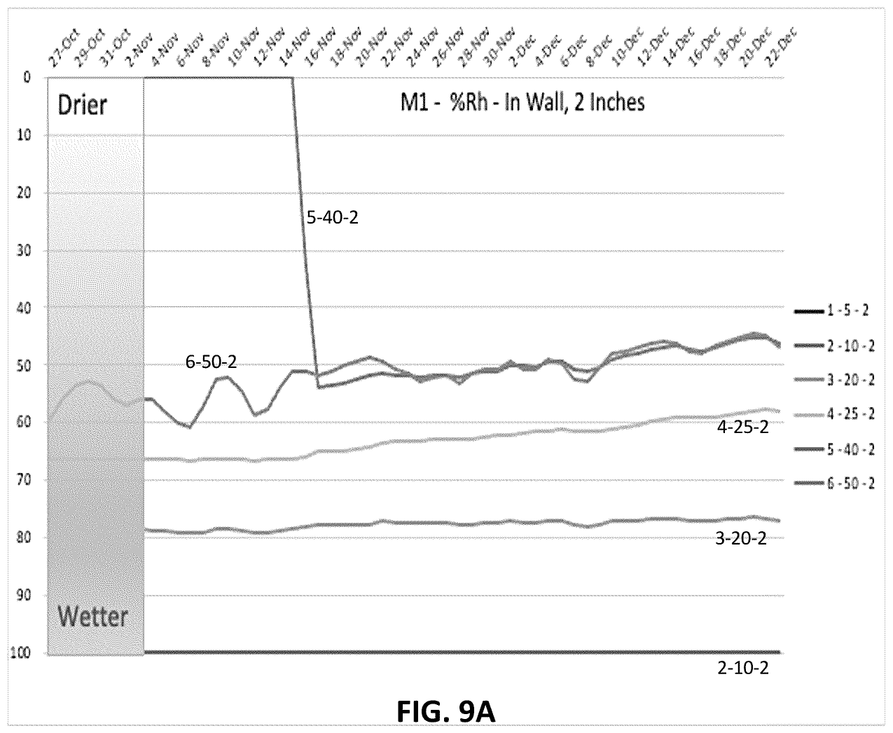

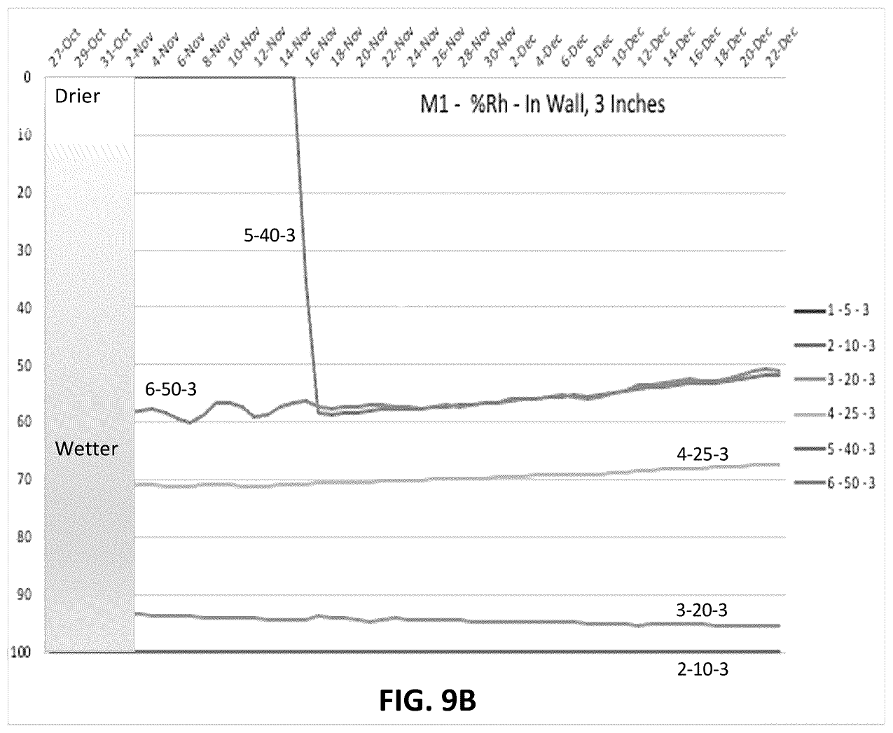

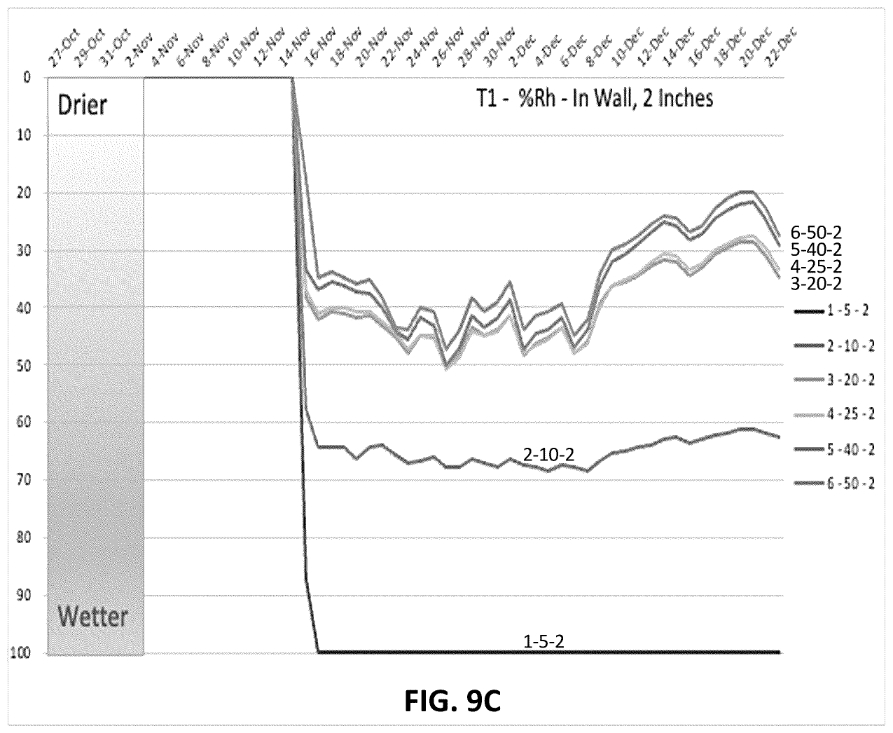

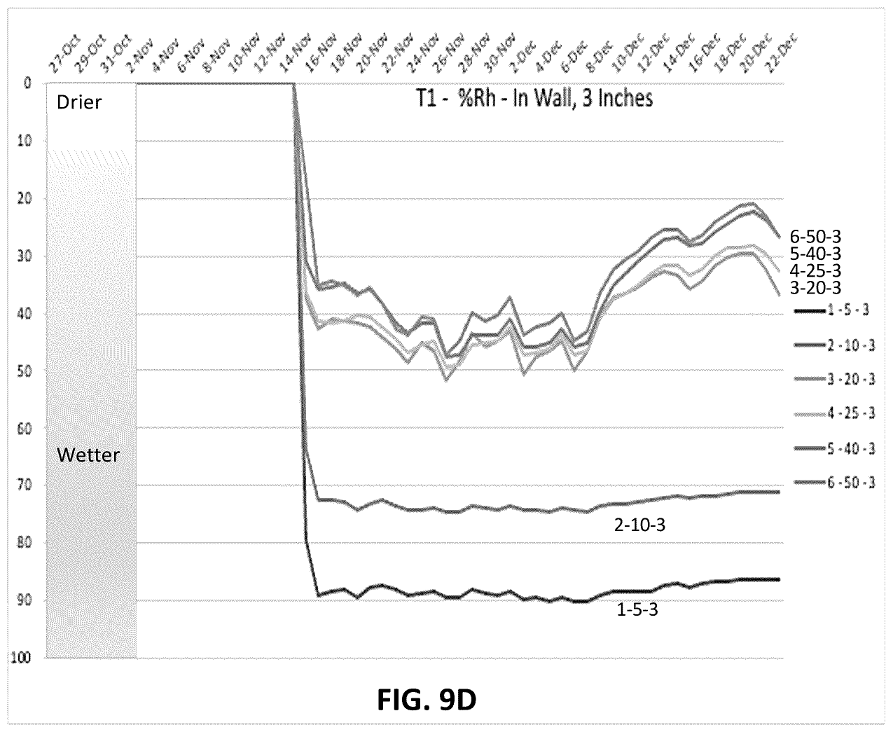

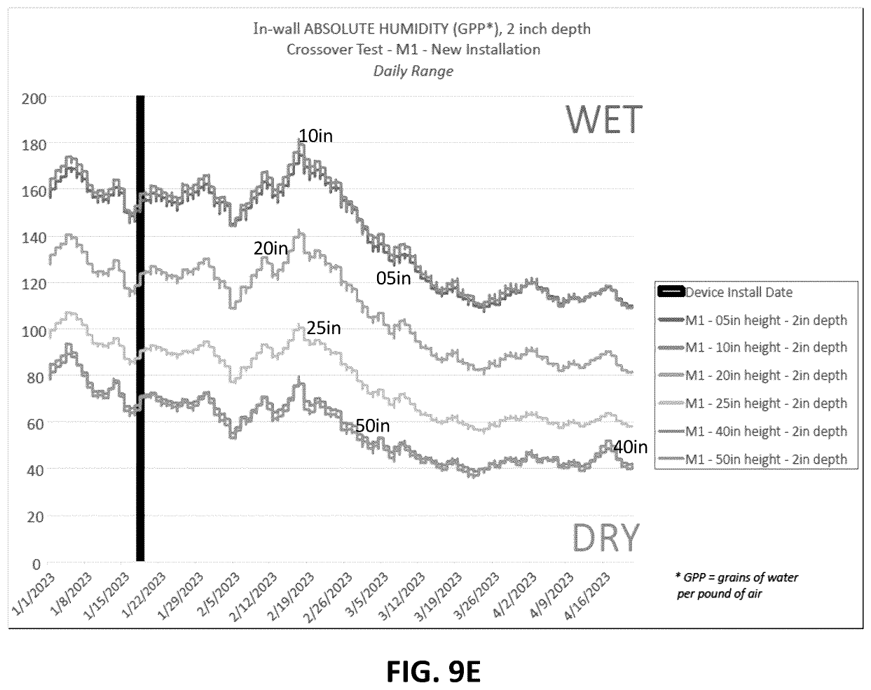

FIG. 9A illustrates a graph demonstrating internal wall % relative humidity over time in an unremediated state. The relative humidity is measured 2.0 in. (5.08 cm) into a porous wall from the interior surface (that is, the surface facing into the building). The internal wall % relative humidity is measured at locations 10.0 in. (25.4 cm), 20.0 in. (50.8 cm), 25.0 in. (63.5 cm), 40.0 in. (101.6 cm), and 50.0 in. (127.0 cm) from the floor.

FIG. 9B illustrates a graph demonstrating internal wall % relative humidity over time in an unremediated state. The relative humidity is measured 3.0 in. (7.62 cm) into a porous wall from the interior surface (that is, the surface facing into the building). The internal wall % relative humidity is measured at locations 10.0 in. (25.4 cm), 20.0 in. (50.8 cm), 25.0 in. (63.5 cm), 40.0 in. (101.6 cm), and 50.0 in. (127.0 cm) from the floor.

FIG. 9C illustrates a graph demonstrating internal wall % relative humidity over time in a remediated state, exposed to device 100, 200, 300, 500, 600, 700. The relative humidity is measured 2.0 in. (5.08 cm) into a porous wall from the interior surface (that is, the surface facing into the building). The internal wall % relative humidity is measured at locations 5.0 in. (12.7 cm), 10.0 in. (25.4 cm), 20.0 in. (50.8 cm), 25.0 in. (63.5 cm), 40.0 in. (101.6 cm), and 50.0 in. (127.0 cm) from the floor.

FIG. 9D illustrates a graph demonstrating internal wall % relative humidity over time in a remediated state, exposed to device 100, 200, 300, 500, 600, 700. The relative humidity is measured 3.0 in. (7.62 cm) into a porous wall from the interior surface (that is, the surface facing into the building). The internal wall % relative humidity is measured at locations 5.0 in. (12.7 cm), 10.0 in. (25.4 cm), 20.0 in. (50.8 cm), 25.0 in. (63.5 cm), 40.0 in. (101.6 cm), and 50.0 in. (127.0 cm) from the floor.

Each graph illustrated in FIGS. 9A-9D are generated from data taken in the same building. The graphs illustrated in FIGS. 9C and 9D show a great reduction in the % relative humidity of the porous wall at greater measurement heights, with the % relative humidity concentrating at the lowest height or lowest two measurement heights, indicating that moisture in the wall due to rising damp is falling down the wall due to the effects of gravity. The graphs illustrated in FIGS. 9A and 9B show an un-remediated % relative humidity that is greater than the remediated % relative humidity illustrated in FIGS. 9C and 9D, and also show that the unremediated % relative humidity values are spread over all of the measurement heights.

FIG. 9E illustrates a graph demonstrating internal wall absolute humidity over a 3.5 month period of time including data before and after the installation of device 100, 200, 300, 500, 600, 700. The relative humidity is measured 2.0 in. (5.08 cm) into a porous wall from the interior surface (that is, the surface facing into the building). The internal wall absolute humidity is measured at locations 5.0 in. (12.7 cm), 10.0 in. (25.4 cm), 20.0 in. (50.8 cm), 25.0 in. (63.5 cm), 40.0 in. (101.6 cm), and 50.0 in. (127.0 cm) from the floor. As illustrated, all absolute humidity measurements maintain a fairly constant relation to one another throughout the duration of the test. As expected, the absolute humidity at each vertical location generally increased from the date of installation until it peaked between Feb. 12, 2023 and Feb. 19, 2023, after which the absolute humidity at each vertical location continuously decreased through the remainder of the test period to levels significantly lower than the pre-installation levels. The peak between Feb. 12, 2023 and Feb. 19, 2023 results from moisture within the porous wall moving downwardly through the wall due to the effect of gravity on the moisture, and thus causing greater values of absolute humidity to be recorded at each level for a period of time as the moisture from locations above passes down to locations below.

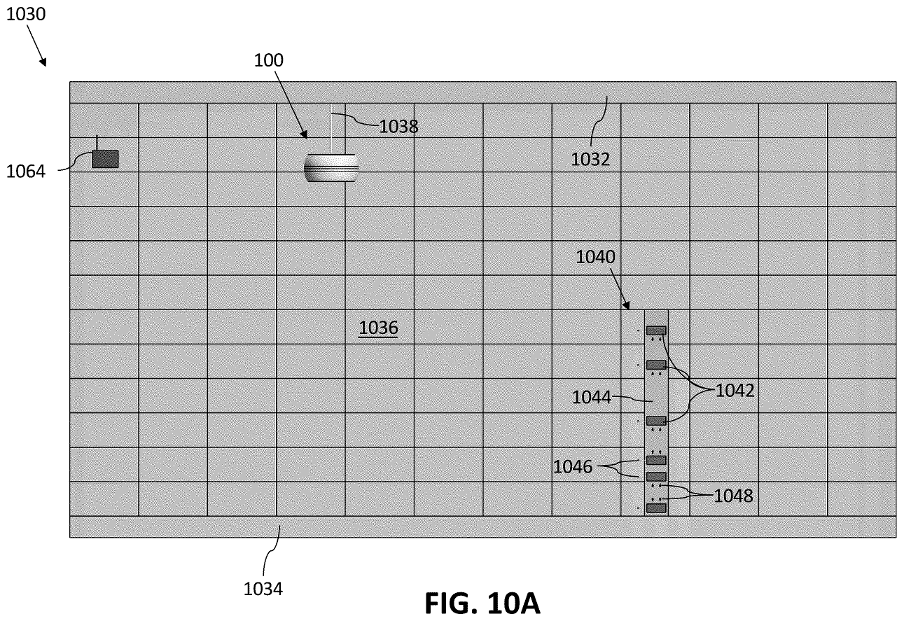

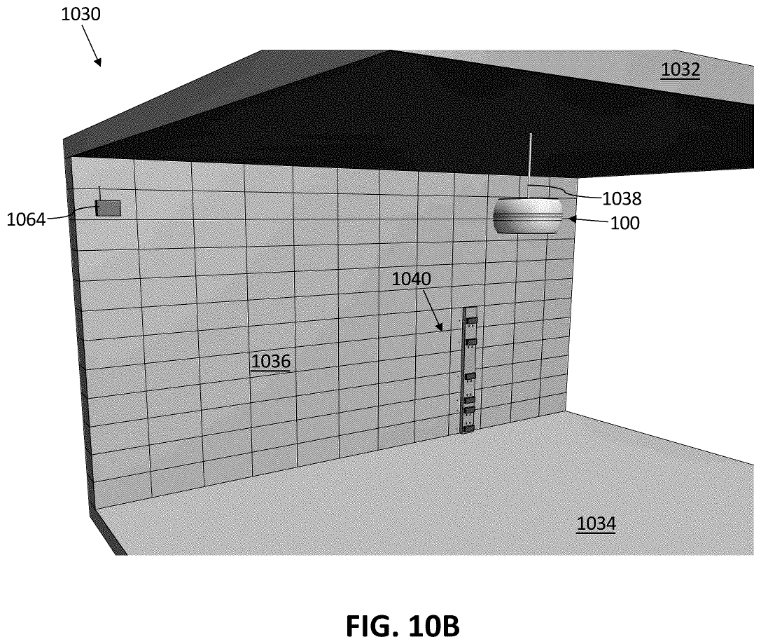

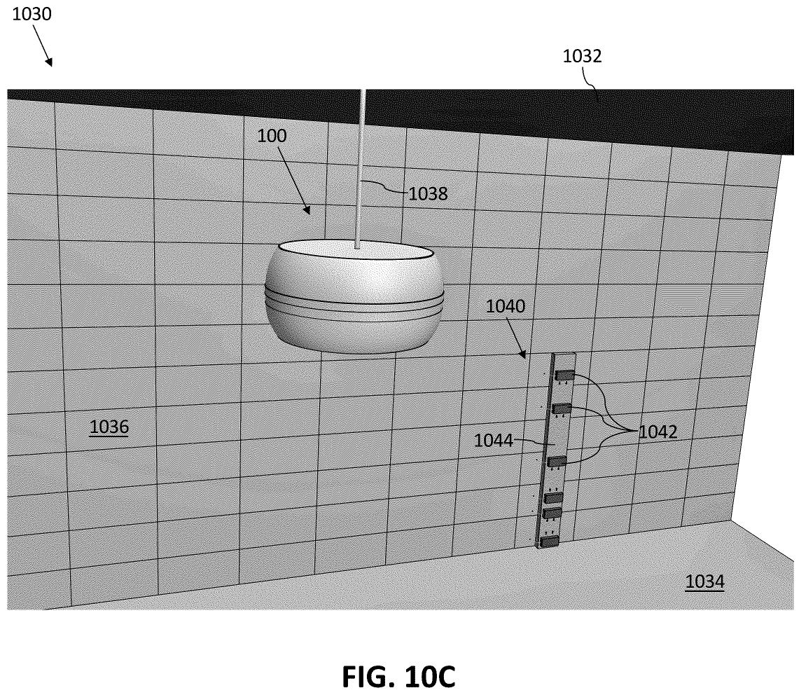

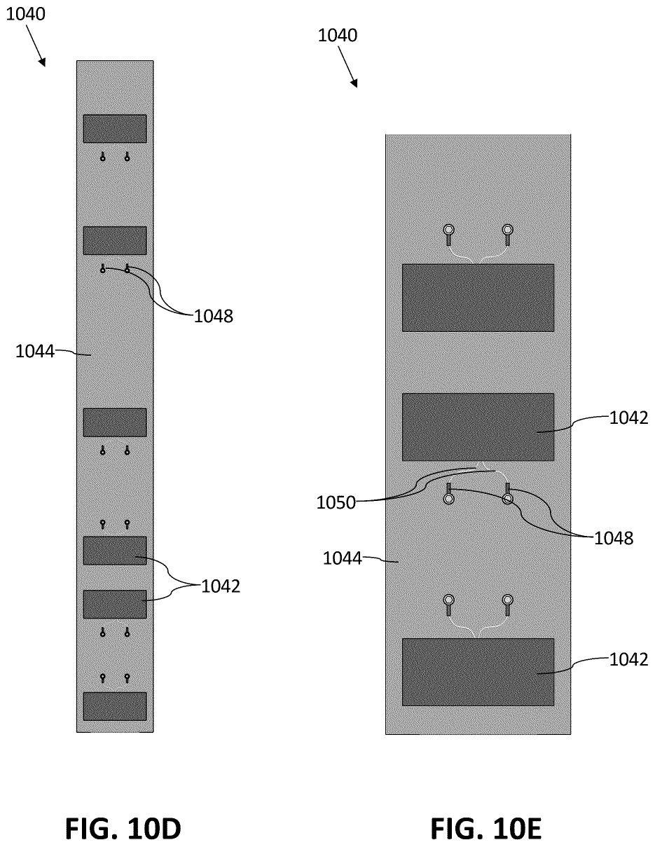

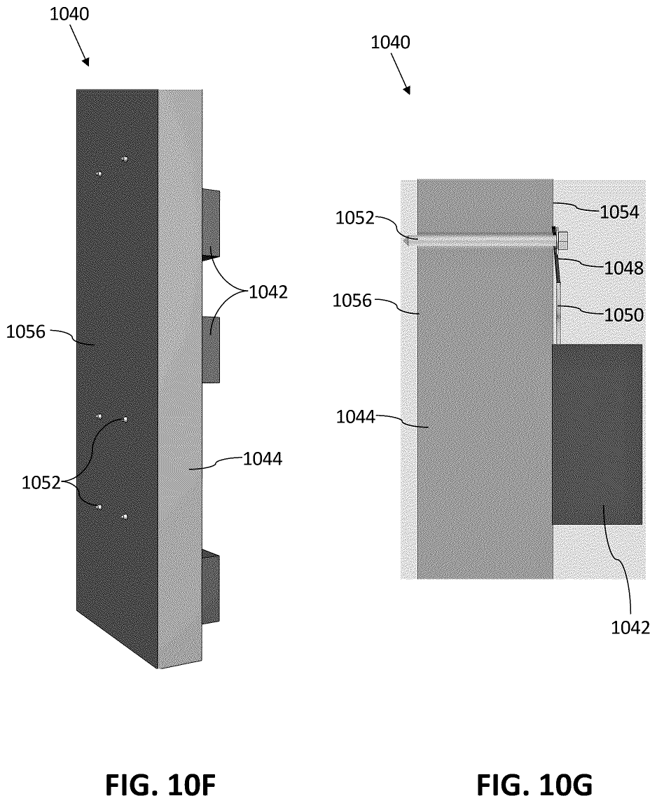

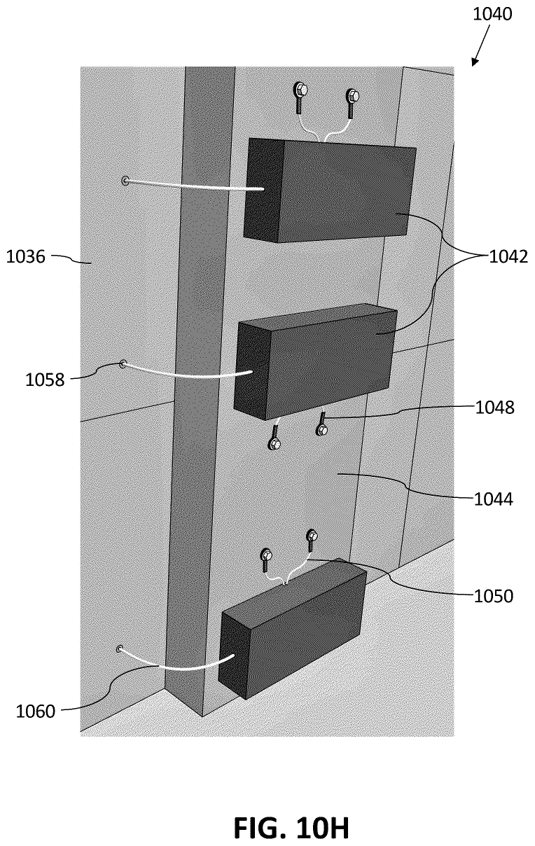

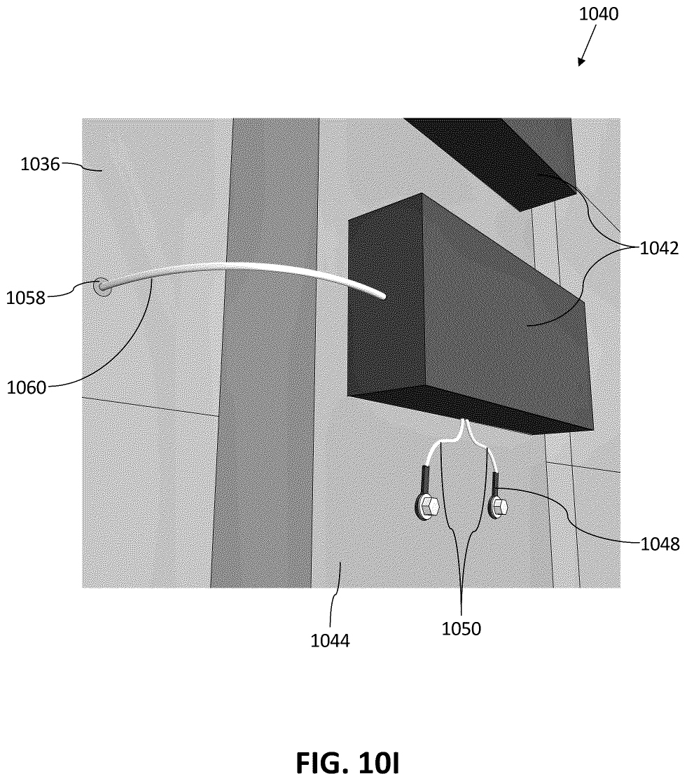

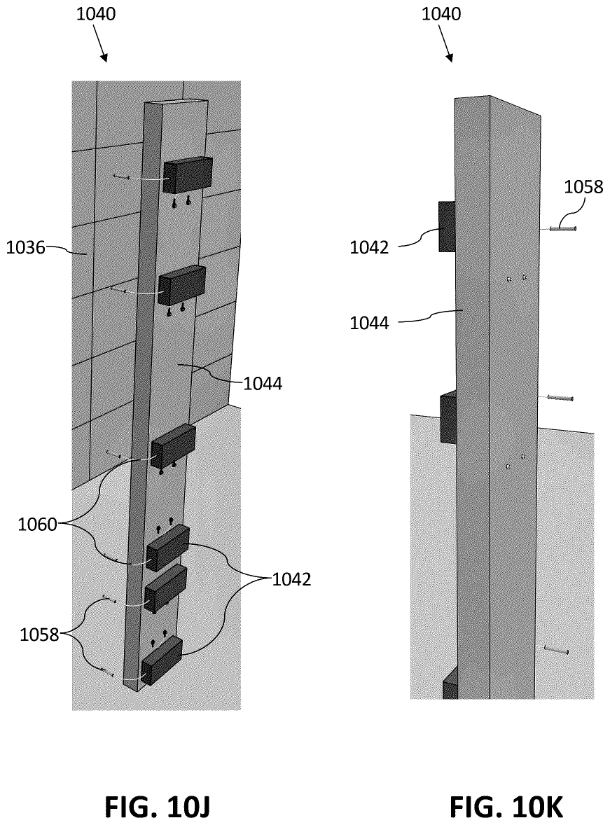

FIGS. 10A-10C illustrate a system 1030 for reducing moisture in porous materials, including device 100, 200, 300, 500, 600, 700 for reduction of moisture in porous materials. System 1030 may include a ceiling 1032 from which device 100, 200, 300, 500, 600, 700 is suspended by a rod 1038. System may include a floor 1034 and a wall 1036. Wall 1036 may be oriented between ceiling 1032 and floor 1034. System 1030 may be contained in a building, including for example a basement or ground contacting level of a building.

Wall 1036 is formed from a porous material, including for example, building materials such as concrete, cement, cinder blocks, bricks, mortar, and the like. Wall 1036 may contain moisture, including moisture from rising damp.

A sensor array 1040 may be placed in contact with wall 1036. Sensor array 1040 may be fastened to wall 1036 by fasteners, adhesive, or the like. Sensor array 1040 may include a plurality of sensors 1042 arranged vertically at different heights along wall 1036. Sensor array 1040 may include at least one sensor 1042. Sensor 1042 may be capable of sensing temperature, relative humidity, and/or moisture content of the material.

Sensors 1042 may be fixed to a support element 1044. Support element 1044 may be formed from a material that is permeable to moisture, including for example, wood. Support element 1044 may be formed from any of a variety of materials, including a polymer, a metal, an organic material, a composite, an alloy, and the like.

Support element 1044 may be placed in contact with wall 1036. Support element 1044 may be fastened to wall 1036 by fasteners, adhesive, or the like. Where support element 1044 is permeable to moisture, moisture in wall 1036 may permeate into support element 1044, which moisture can be sensed by sensor 1042.

System 1030 may include a wireless gateway 1064. Wireless gateway 1064 may include an onboard air quality monitor. Wireless gateway 1064 may include an ethernet, WiFi, and/or cellular internet connection. Wireless gateway 1064 may include a particle counter capable of counting 1.0 micron particles, 2.5 micron particles, and/or 10.0 micron particles. Wireless gateway 1064 may include a temperature and humidity sensor, which may be a probe sensor plugged into a port on wireless gateway 1064. Wireless gateway 1064 may include a CO₂ sensor capable of sensing 0 PPM to 5,000 PPM, plus or minus 50 PPM+5% reading value. Wireless gateway 1064 may include a CO sensor capable of sensing 0 PPM to 500 PPM with 0.1 PPM resolution. Wireless gateway 1064 may include a sound pressure level meter. Wireless gateway 1064 may include a manometer to measure differential pressure with a range of plus or minus 250 Pa with resolution down to 0.01 Pa. Wireless gateway 1064 may include a data logging flash memory as a backup where internet connection is interrupted. Wireless gateway 1064 may be an OmniSense G-7 Wireless Air Quality Monitor and Gateway manufactured by OmniSense LLC in Lady's Island, South Carolina, United States.

Wireless gateway 1064 is connected to the one or more sensor 1042 via a wireless connection. Wireless gateway 1064 may automatically upload collected data to a designated server for storage and/or analysis.

Wireless gateway 1064 may be mounted within the necessary proximity of one or more sensor 1042 to establish a reliable wireless connection. For example, wireless gateway 1064 may be mounted to wall 1036, ceiling 1032, floor 1034, or any other object within the necessary proximity.

FIGS. 10D-10K illustrate sensor array 1040 of system 1030. Sensor array 1040 includes at least one sensor 1042. Sensor array 1040 may include a plurality of sensors 1042 arranged at various heights along wall 1036. Sensors 1042 may be arranged at various heights to monitor moisture levels within porous materials, such as wall 1036, at various heights.

Sensors 1042 may be used on a vertical structure, such as wall 1036, prior to application of device 100, 200, 300, 500, 600, 700 to establish a baseline measurement of moisture within the vertical structure. One may view data from sensors 1042 during this baseline stage to ensure that moisture levels are remaining substantially constant.

Device 100, 200, 300, 500, 600, 700 works by causing moisture within a vertical structure, such as wall 1036, to draw downwardly under the force of gravity and ultimately out of the vertical structure. That is, device 100, 200, 300, 500, 600, 700 reverses the effect of rising damp, wherein moisture is wicked upward through a vertical structure via capillary action. Device 100, 200, 300, 500, 600, 700 may interfere with, or reduce, natural capillary action in masonry. In this manner, during moisture mitigation/remediation in the presence of device 100, 200, 300, 500, 600, 700, one may monitor data generated by sensors 1042 to ensure that moisture levels in the porous materials monitored by sensors 1042 are decreasing in turn from the highest position to each successively lower position over a period of time. As the moisture traverses down the vertical structure under the force of gravity, higher sensors 1042 may demonstrate lower moisture content at higher positions, while lower sensors 1042 may at least for a time demonstrate higher moisture content (having received additional moisture from above) as the moisture is working its way down and out of the vertical structure. After some time, moisture levels will reduce at all positions of sensors 1042 if device 100, 200, 300, 500, 600, 700 is properly deployed.

Where moisture levels are not as expected at the relevant positions of sensors 1042, device 100, 200, 300, 500, 600, 700 may not be properly deployed and may require adjustment to effect the reduction of moisture in vertical structures as described. A user may assess and redeploy device 100, 200, 300, 500, 600, 700, again analyzing sensors 1042 to determine whether device 100, 200, 300, 500, 600, 700 has been successfully redeployed.

Each sensor 1042 may include at least one socket to connect a moisture probe 1048, formed from a pair of conductive terminals. Moisture probe 1048 may be connected to sensor 1042 by cabling 1050. Moisture probes 1048 may make up a pin type resistance moisture meter. Moisture probes 1048 may be fixed to support element 1044 by conductive fasteners 1052. Fasteners 1052 may extend through moisture probe 1048 terminals on the front side 1054 of support element 1044, through the thickness of support element 1044, and out the rear side 1056 of support element 1044. Conductive fasteners 1052 may extend out of rear side 1056 of support element 1044 a sufficient distance to contact a vertical structure, such as wall 1036. Moisture probe 1048 may measure moisture within wall 1036 by assessing the resistivity of wall 1036 using an electrical current flowing through moisture probe 1048 terminals and conductive fasteners 1052. A wall with greater moisture content will have less resistivity, whereas a wall with less moisture content will have greater resistivity. Sensor 1042 may be calibrated to determine moisture content based upon resistivity.

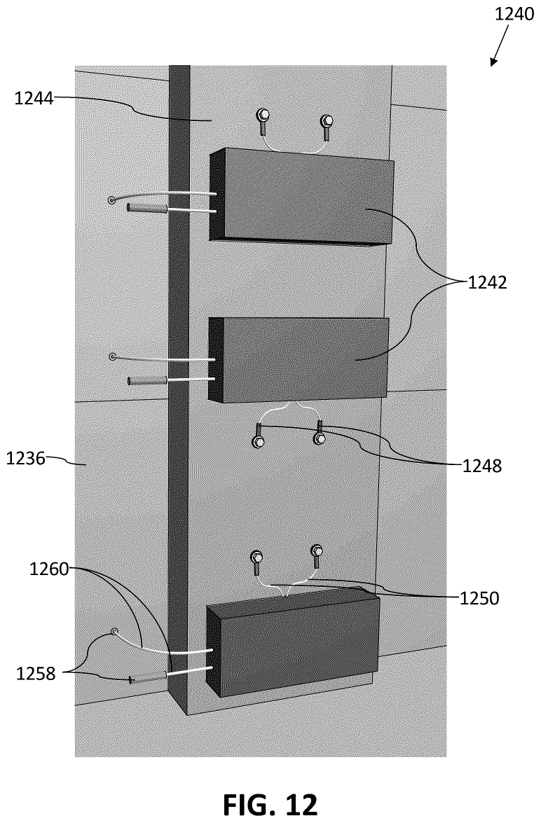

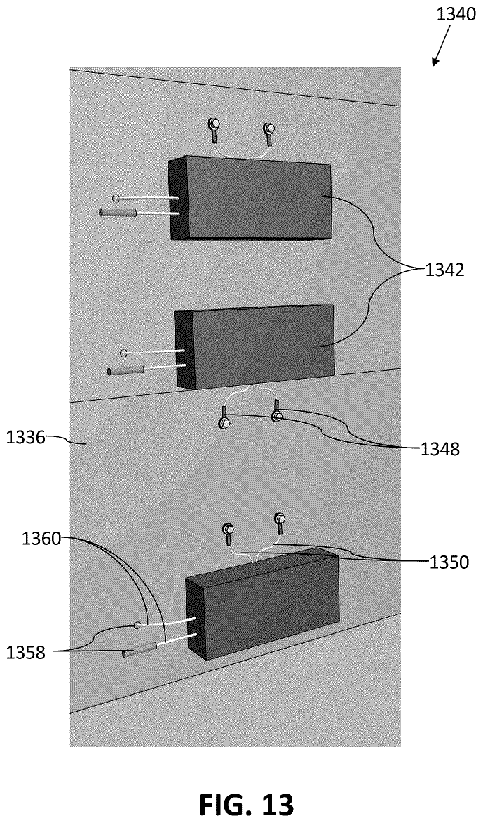

Each sensor 1042 may include at least one port to connect a temperature and relative humidity probe 1058. Temperature and relative humidity probe 1058 may be connected to sensor 1042 by cabling 1060. Temperature and relative humidity probe 1058 may be inserted into a hole within a porous vertical structure, such as wall 1036, to measure the temperature and relative humidity of the structure. Alternatively, or additionally, temperature and relative humidity probe 1058 may be exposed to ambient air adjacent to the porous vertical structure, such as wall 1036, as illustrated in FIGS. 12 and 13.

Sensor 1042 may be a wireless sensor with two plug in ports for two channels of temperature and relative humidity probes 1058 and a socket for a moisture probe 1048. Sensor 342 may include a temperature and relative humidity accuracy of plus or minus 0.3 degrees C. and plus or minus 2.0% relative humidity.

Sensor 1042 may include a data logging memory storage for up to 64,000 readings where a single reading includes two temperature/humidity pairs and moisture data. Readings may be stored within sensor 1042's memory where no gateway (e.g., wireless gateway 1064) is detected within wireless range. If a gateway is present, sensor 1042 uploads all readings stored in memory and continues to send regular readings to the gateway. Sensor 1042 may be an OmniSense S-2 Wireless Sensor manufactured by OmniSense LLC in Lady's Island, South Carolina, United States.

Sensor array 1040 may be prepared off-site by securing a series of sensors 1042 and moisture probes 1048 to support element 1044. An installer may secure sensor array 1040 to a vertical structure, such as wall 1036, with screws, bolts, adhesive, or another fastener (not shown). Temperature and relative humidity probes 1058 may be secured within holes drilled in a vertical structure, such as wall 1036, at the time of installation of sensor array 1040.

Alternatively, sensor array 1040 may be prepared on-site by the installer.

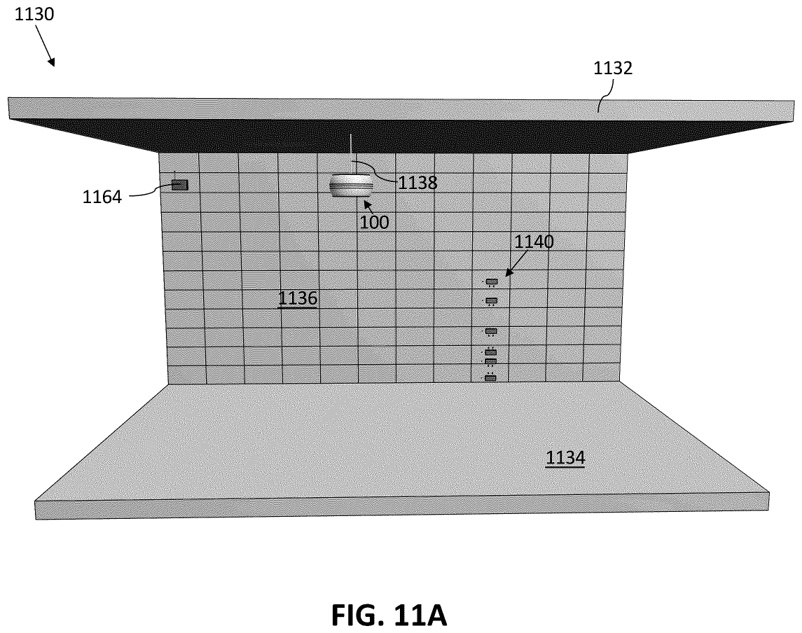

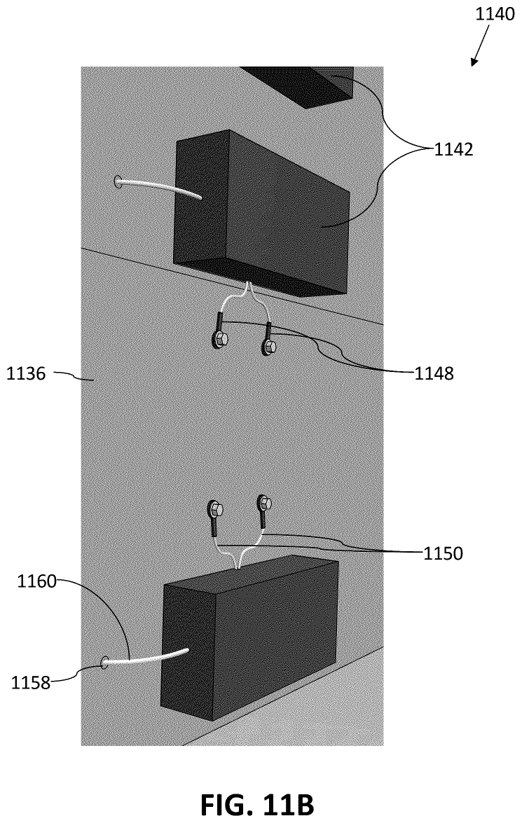

FIGS. 11A and 11B illustrate a system 1130 including a sensor array 1140 applied to a wall 1136 in the presence of device 100, 200, 300, 500, 600, 700. System 1130 may be the same as system 1030, with the exception that sensors 1142 are attached directly to a vertical structure, such as wall 1136, rather than to a support element (e.g., support element 1044), which is then attached to the vertical structure.

System 1130 may include a ceiling 1132 from which device 100, 200, 300, 500, 600, 700 is suspended by a rod 1138. System may include a floor 1134 and a wall 1136. Wall 1136 may be oriented between ceiling 1132 and floor 1134. System 1130 may be contained in a building, including for example a basement or ground contacting level of a building. System 1130 may include a wireless gateway 1164.

Sensor array 1140 may include at least one sensor 1142, each sensor 1142 including at least one moisture probe 1148 that may be connected to sensor 1142 by cabling 1150. Each sensor 1142 may include at least one temperature and relative humidity probe 1158, which may be connected to sensor 1142 by cabling 1160.

Each sensor 1142 in sensor array 1140 may be attached directly to a vertical structure, such as wall 1136, via a fastener, adhesive, or the like (not shown).

FIG. 12 illustrates a sensor array 1240 applied to a wall 1236. Sensor array 1240 may be substantially the same as sensor array 1040. Sensor array 1240 may include at least one sensor 1242, each sensor 1242 including at least one moisture probe 1248 that may be connected to sensor 1242 by cabling 1250.

Each sensor 542 includes a plurality of temperature and relative humidity probes 558, which may be connected to sensor 542 by cabling 560. A first temperature and relative humidity probe 558 is inserted into a hole within a porous vertical structure, such as wall 536, to measure the temperature and relative humidity of the structure. A second temperature and relative humidity probe 558 is connected to sensor 542 and exposed to the ambient environment, not inserted into a hole within a porous vertical structure, to measure the temperature and relative humidity of the ambient environment.

FIG. 13 illustrates a sensor array 1340 applied to a wall 1336. Sensor array 1340 may be substantially the same as sensor array 1140. Sensor array 1340 may include at least one sensor 1342, each sensor 1342 including at least one moisture probe 1348 that may be connected to sensor 1342 by cabling 1350.

Each sensor 1342 includes a plurality of temperature and relative humidity probes 1358, which may be connected to sensor 1342 by cabling 1360. A first temperature and relative humidity probe 1358 is inserted into a hole within a porous vertical structure, such as wall 1336, to measure the temperature and relative humidity of the structure. A second temperature and relative humidity probe 1358 is connected to sensor 1342 and exposed to the ambient environment, not inserted into a hole within a porous vertical structure, to measure the temperature and relative humidity of the ambient environment.

In another aspect, a system for reduction of moisture in porous materials is provided, comprising: a device that interferes with and reduces natural capillary action in masonry; and at least one sensor oriented near the device, the sensor including a temperature and relative humidity probe and a moisture probe. The device may be an RF antenna tuned to the resonant frequency of hydrogen. The device may be a passive antenna. The device may include an upper conductive board comprising: a first side and a second side, one or more conductive track arranged in a spiral on the first side, and one or more conductive track arranged in a spiral on the second side; a lower conductive board comprising: a first side, one or more conductive track arranged in a spiral on the first side; and a conductive coupler extending from a radially inner core of the first side of the lower conductive board to a radially inner core of the second side of the upper conductive board. In another aspect, at least one of the temperature and relative humidity probe and the moisture probe are attached to a porous vertical structure. In another aspect, a plurality of sensors are oriented at various heights of the porous vertical structure, each of the plurality of sensors including the temperature and relative humidity probe and the moisture probe. In another aspect, the sensor is a wireless sensor. In another aspect, the system further comprises a wireless gateway in wireless communication with the wireless sensor, wherein the wireless gateway includes one or more of an ethernet, WiFi, or cellular internet connection. In another aspect, the at least one sensor is attached to a front side of a support element. In another aspect, the moisture probe includes a pair of terminals, and wherein fasteners extend through each terminal on the front side of the support element, through a thickness of the support element, and out of the rear side of the support element to contact a porous vertical structure. In another aspect, the temperature and relative humidity probe is oriented in a hole in a porous vertical structure. In another aspect, the temperature and relative humidity probe is arranged in an ambient environment containing the sensor. In another aspect, a plurality of sensors are oriented on a vertical support element at various heights, and wherein the vertical support element is attached to a porous vertical structure. In another aspect, a method for reduction of moisture in porous materials is provided, using any of the systems and system parameters described herein.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of alternative aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A system for reduction of moisture in porous materials, comprising:
a device for reducing moisture in porous materials comprising:
an upper conductive board comprising:
a first side and a second side,
one or more conductive track arranged in a spiral on the first side, and
one or more conductive track arranged in a spiral on the second side;
a lower conductive board comprising:
a first side,
one or more conductive track arranged in a spiral on the first side;
a conductive coupler extending from a radially inner core of the first side of the lower conductive board to a radially inner core of the second side of the upper conductive board; and
at least one sensor oriented near the device, the sensor including a temperature and relative humidity probe and a moisture probe.

2. The system of claim 1, wherein at least one of the temperature and relative humidity probe and the moisture probe are attached to a porous vertical structure.

3. The system of claim 2, wherein a plurality of sensors are oriented at various heights of the porous vertical structure, each of the plurality of sensors including the temperature and relative humidity probe and the moisture probe.

4. The system of claim 1, wherein the sensor is a wireless sensor.

5. The system of claim 4, further comprising a wireless gateway in wireless communication with the wireless sensor, wherein the wireless gateway includes one or more of an ethernet, WiFi, or cellular internet connection.

6. The system of claim 1, wherein the at least one sensor is attached to a front side of a support element.

7. The system of claim 6, wherein the moisture probe includes a pair of terminals, and wherein fasteners extends through each terminal on the front side of the support element, through a thickness of the support element, and out of the rear side of the support element to contact a porous vertical structure.

8. The system of claim 1, wherein the temperature and relative humidity probe is oriented in a hole in a porous vertical structure.

9. The system of claim 1, wherein the temperature and relative humidity probe is arranged in an ambient environment containing the sensor.

10. The system of claim 1, wherein a plurality of sensors are oriented on a vertical support element at various heights, and wherein the vertical support element is attached to a porous vertical structure.

11. A method for reduction of moisture in porous materials, comprising:
providing a device for reducing moisture in porous materials comprising:
an upper conductive board comprising:
a first side and a second side,
one or more conductive track arranged in a spiral on the first side, and
one or more conductive track arranged in a spiral on the second side;
a lower conductive board comprising:
a first side,
one or more conductive track arranged in a spiral on the first side;
a conductive coupler extending from a radially inner core of the first side of the lower conductive board to a radially inner core of the second side of the upper conductive board; and
providing at least one sensor oriented near the device, the sensor including a temperature and relative humidity probe and a moisture probe,
wherein the sensor collects temperature data, relative humidity data, and moisture data in a porous vertical structure.

12. The method of claim 11, wherein at least one of the temperature and relative humidity probe and the moisture probe are attached to the porous vertical structure.

13. The method of claim 12, wherein a plurality of sensors are oriented at various heights of the porous vertical structure, each of the plurality of sensors including the temperature and relative humidity probe and the moisture probe.

14. The method of claim 11, wherein the sensor is a wireless sensor.

15. The method of claim 14, further comprising a wireless gateway in wireless communication with the wireless sensor, wherein the wireless gateway includes one or more of an ethernet, WiFi, or cellular internet connection.

16. The methods of claim 15, wherein the temperature data, relative humidity data, and moisture data is wirelessly communicated to the wireless gateway, and then wirelessly communicated via one or more of the ethernet, WiFi, or cellular internet connection to a designated server for analysis.

17. The method of claim 11, wherein the at least one sensor is attached to a front side of a support element.

18. The method of claim 17, wherein the moisture probe includes a pair of terminals, and wherein fasteners extends through each terminal on the front side of the support element, through a thickness of the support element, and out of the rear side of the support element to contact a porous vertical structure.

19. The method of claim 11, wherein the temperature and relative humidity probe is oriented in a hole in a porous vertical structure.

20. The method of claim 11, wherein a plurality of sensors are oriented on a vertical support element at various heights, and wherein the vertical support element is attached to a porous vertical structure.
